(19) United States
(12) Patent Application Publication
(10) Pub. No.: US 2024/0154665 A1
(43) Pub. Date: May 9, 2024

(54) REPORTING QUANTITY OF TRANSMIT ANTENNAS FOR WIRELESS COMMUNICATIONS

(71) Applicant: QUALCOMM Incorporated, San Diego, CA (US)

(72) Inventors: Jacob Pick, Beit Zayit (IL); Shay Landis, Hod Hasharon (IL); Peer Berger, Hod Hasharon (IL)

(21) Appl. No.: 18/052,873

(22) Filed: Nov. 4, 2022

(51) Int. Cl. H04B 7/06; H04B 17/10; H04L 27/14

(52) U.S. Cl. CPC H04B 7/0626; H04B 17/102; H04L 27/14

(57) ABSTRACT

Methods, systems, and devices for wireless communication are described. In some systems, a user equipment (UE) may receive control signaling that indicates a quantity of transmit antennas at a network entity. The quantity of transmit antennas may include antennas that are activated for a downlink transmission to the UE. The UE may transmit a channel state information (CSI) report that indicates a set of one or more CSI parameters. The set of one or more CSI parameters may be based on the quantity of transmit antennas at the network entity indicated via the control signaling. After transmitting the CSI report, the UE may communicate with the network entity based on the set of one or more CSI parameters indicated via the CSI report.

### FIELD OF TECHNOLOGY

The following relates to wireless communication, including reporting quantity of transmit antennas for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a UE may measure reference signals from a network entity to determine channel state information (CSI) parameters. The UE may transmit a CSI report to a network entity to indicate the CSI parameters and the network entity may perform downlink transmissions to the UE in accordance with the reported CSI parameters.

### SUMMARY

The described techniques relate to improved methods, systems, devices, and apparatuses that support reporting quantity of transmit antennas for wireless communications. For example, the described techniques provide for a network entity to transmit control signaling to a user equipment (UE) to indicate a quantity of transmit antennas at the network entity. The quantity of transmit antennas may include antennas (e.g., antenna elements, antenna arrays, antenna ports, or the like) that are activated at the network entity for downlink communications with the UE. The UE may determine a set of one or more channel state information (CSI) parameters based on the quantity of transmit antennas at the network entity. For example, the UE may determine a precoding matrix indicator (PMI), a rank, a modulation and coding scheme (MCS), or any combination thereof for receiving the downlink transmission based on the quantity of transmit antennas. Additionally, or alternatively, the UE may select a demodulator to use for demodulating the downlink transmission based on the quantity of transmit antennas. The UE may transmit a CSI report to the network entity to indicate the set of one or more CSI parameters. The UE and the network entity may communicate according to the CSI parameters indicated via the CSI report.

A method for wireless communication at a UE is described. The method may include receiving control signaling that indicates a quantity of transmit antennas at a network entity, the quantity of transmit antennas including antennas that are activated for a downlink transmission to the UE, transmitting a CSI report including a set of one or more CSI parameters, the set of one or more CSI parameters based on the indicated quantity of transmit antennas at the network entity, and communicating with the network entity based on the set of one or more CSI parameters indicated via the CSI report.

An apparatus for wireless communication at a UE is described. The apparatus may include a processor, memory coupled with the processor, and instructions stored in the memory. The instructions may be executable by the processor to cause the apparatus to receive control signaling that indicates a quantity of transmit antennas at a network entity, the quantity of transmit antennas including antennas that are activated for a downlink transmission to the UE, transmit a CSI report including a set of one or more CSI parameters, the set of one or more CSI parameters based on the indicated quantity of transmit antennas at the network entity, and communicate with the network entity based on the set of one or more CSI parameters indicated via the CSI report.

Another apparatus for wireless communication at a UE is described. The apparatus may include means for receiving control signaling that indicates a quantity of transmit antennas at a network entity, the quantity of transmit antennas including antennas that are activated for a downlink transmission to the UE, means for transmitting a CSI report including a set of one or more CSI parameters, the set of one or more CSI parameters based on the indicated quantity of transmit antennas at the network entity, and means for communicating with the network entity based on the set of one or more CSI parameters indicated via the CSI report.

A non-transitory computer-readable medium storing code for wireless communication at a UE is described. The code may include instructions executable by a processor to receive control signaling that indicates a quantity of transmit antennas at a network entity, the quantity of transmit antennas including antennas that are activated for a downlink transmission to the UE, transmit a CSI report including a set of one or more CSI parameters, the set of one or more CSI parameters based on the indicated quantity of transmit antennas at the network entity, and communicate with the network entity based on the set of one or more CSI parameters indicated via the CSI report.

In some examples of the method, apparatuses, and non-transitory computer-readable medium described herein, receiving the control signaling may include operations, features, means, or instructions for receiving a set of multiple control messages, where a first control message of the set of multiple control messages indicates the quantity of transmit antennas that may be activated at the network entity at a first time, and where one or more other control messages of the set of multiple control messages indicate one or more other quantities of transmit antennas that may be activated at the network entity at one or more other times different than the first time.

In some examples of the method, apparatuses, and non-transitory computer-readable medium described herein, receiving the set of multiple control messages may include operations, features, means, or instructions for receiving the set of multiple control messages periodically, where each of the set of multiple control messages indicates a respective quantity of transmit antennas that may be activated at the network entity for a respective time period associated with a periodicity of the set of multiple control messages.

In some examples of the method, apparatuses, and non-transitory computer-readable medium described herein, receiving the set of multiple control messages may include operations, features, means, or instructions for receiving the set of multiple control messages aperiodically or periodically, where one or more the set of multiple control messages indicates a respective change in the quantity of transmit antennas that may be activated at the network entity.

In some examples of the method, apparatuses, and non-transitory computer-readable medium described herein, receiving the control signaling may include operations, features, means, or instructions for receiving downlink control information (DCI) that indicates the quantity of transmit antennas.

In some examples of the method, apparatuses, and non-transitory computer-readable medium described herein, receiving the control signaling may include operations, features, means, or instructions for receiving radio resource control (RRC) signaling that indicates the quantity of transmit antennas.

Some examples of the method, apparatuses, and non-transitory computer-readable medium described herein may further include operations, features, means, or instructions for switching from a first demodulator of a set of multiple demodulators of the UE to a second demodulator of the set of multiple demodulators based on the indicated quantity of transmit antennas.

Some examples of the method, apparatuses, and non-transitory computer-readable medium described herein may further include operations, features, means, or instructions for identifying a quantity of spatial streams associated with the downlink transmission, selecting the second demodulator from among the set of multiple demodulators of the UE to use for demodulating the downlink transmission based on a relationship between the indicated quantity of transmit antennas and the quantity of spatial streams associated with the downlink transmission, where switching from the first demodulator to the second demodulator may be based on selecting the second demodulator, receiving the downlink transmission, and demodulating the downlink transmission using the selected demodulator.

In some examples of the method, apparatuses, and non-transitory computer-readable medium described herein, each demodulator of the set of multiple demodulators of the UE may be associated with a respective demodulation complexity and the method, apparatuses, and non-transitory computer-readable medium may include further operations, features, means, or instructions for determining that the indicated quantity of transmit antennas may be greater than a quantity of spatial streams associated with the downlink transmission by at least a threshold quantity or threshold ratio and selecting the second demodulator associated with a second complexity that may be less than a first complexity associated with the first demodulator and one or more other complexities associated with one or more other demodulators of the set of multiple demodulators based on the determining, where switching from the first demodulator to the second demodulator may be based on selecting the second demodulator.

Some examples of the method, apparatuses, and non-transitory computer-readable medium described herein may further include operations, features, means, or instructions for detecting a change in one or more channel parameters associated with communications between the UE and the network entity and transmitting a second CSI report to indicate a second set of one or more CSI parameters in response to detecting the change, where a difference between the set of one or more CSI parameters and the second set of one or more CSI parameters may be based on the indicated quantity of antennas at the network entity and the change in the one or more channel parameters.

Some examples of the method, apparatuses, and non-transitory computer-readable medium described herein may further include operations, features, means, or instructions for determining the set of one or more CSI parameters based on conditions at the UE and the indicated quantity of transmit antennas at the network entity, where a value of each CSI parameter of the set of one or more CSI parameters may be correlated to the quantity of transmit antennas at the network entity.

In some examples of the method, apparatuses, and non-transitory computer-readable medium described herein, the set of one or more CSI parameters includes a PMI, a rank, a MCS, or any combination thereof for receiving the downlink transmission.

A method for wireless communication at a network entity is described. The method may include transmitting control signaling that indicates a quantity of transmit antennas at the network entity, the quantity of transmit antennas including antennas that are activated for a downlink transmission to a UE, receiving a CSI report including a set of one or more CSI parameters, the set of one or more CSI parameters based on the indicated quantity of transmit antennas at the network entity, and communicating with the UE based on the set of one or more CSI parameters indicated via the CSI report.

An apparatus for wireless communication at a network entity is described. The apparatus may include a processor, memory coupled with the processor, and instructions stored in the memory. The instructions may be executable by the processor to cause the apparatus to transmit control signaling that indicates a quantity of transmit antennas at the network entity, the quantity of transmit antennas including antennas that are activated for a downlink transmission to a UE, receive a CSI report including a set of one or more CSI parameters, the set of one or more CSI parameters based on the indicated quantity of transmit antennas at the network entity, and communicate with the UE based on the set of one or more CSI parameters indicated via the CSI report.

Another apparatus for wireless communication at a network entity is described. The apparatus may include means for transmitting control signaling that indicates a quantity of transmit antennas at the network entity, the quantity of transmit antennas including antennas that are activated for a downlink transmission to a UE, means for receiving a CSI report including a set of one or more CSI parameters, the set of one or more CSI parameters based on the indicated quantity of transmit antennas at the network entity, and means for communicating with the UE based on the set of one or more CSI parameters indicated via the CSI report.

A non-transitory computer-readable medium storing code for wireless communication at a network entity is described. The code may include instructions executable by a processor to transmit control signaling that indicates a quantity of transmit antennas at the network entity, the quantity of transmit antennas including antennas that are activated for a downlink transmission to a UE, receive a CSI report including a set of one or more CSI parameters, the set of one or more CSI parameters based on the indicated quantity of transmit antennas at the network entity, and communicate with the UE based on the set of one or more CSI parameters indicated via the CSI report.

In some examples of the method, apparatuses, and non-transitory computer-readable medium described herein, transmitting the control signaling may include operations, features, means, or instructions for transmitting a set of multiple control messages, where a first control message of the set of multiple control messages indicates the quantity of transmit antennas that may be activated at the network entity at a first time, and where one or more other control messages of the set of multiple control messages indicate one or more other quantities of transmit antennas that may be activated at the network entity at one or more other times different than the first time.

In some examples of the method, apparatuses, and non-transitory computer-readable medium described herein, transmitting the set of multiple control messages may include operations, features, means, or instructions for transmitting the set of multiple control messages periodically, where each of the set of multiple control messages indicates a respective quantity of transmit antennas that may be activated at the network entity at a respective time period associated with a periodicity of the set of multiple control messages.

In some examples of the method, apparatuses, and non-transitory computer-readable medium described herein, transmitting the set of multiple control messages may include operations, features, means, or instructions for determining a change in the quantity of transmit antennas that may be activated at the network entity and transmitting a control message of the set of multiple control messages to indicate the change in the quantity of transmit antennas, where the set of multiple control messages may be transmitted aperiodically or periodically, and where one or more of the set of multiple control messages indicates a respective change in the quantity of transmit antennas at the network entity.

In some examples of the method, apparatuses, and non-transitory computer-readable medium described herein, transmitting the control signaling may include operations, features, means, or instructions for transmitting DCI that indicates the quantity of transmit antennas.

In some examples of the method, apparatuses, and non-transitory computer-readable medium described herein, transmitting the control signaling may include operations, features, means, or instructions for transmitting RRC signaling that indicates the quantity of transmit antennas.

Some examples of the method, apparatuses, and non-transitory computer-readable medium described herein may further include operations, features, means, or instructions for receiving, after receiving the CSI report, a second CSI report that indicates a second set of one or more CSI parameters, where a difference between the set of one or more CSI parameters indicated via the CSI report and the second set of one or more CSI parameters indicated via the second CSI report may be based on the quantity of antennas at the network entity and a change in one or more channel parameters associated with communications between the network entity and the UE and transmitting a second downlink transmission based on the second set of one or more CSI parameters indicated via the second CSI report.

In some examples of the method, apparatuses, and non-transitory computer-readable medium described herein, a value of each CSI parameter of the set of one or more CSI parameters may be correlated to the quantity of transmit antennas at the network entity.

In some examples of the method, apparatuses, and non-transitory computer-readable medium described herein, the set of one or more CSI parameters includes a PMI, a rank, a MCS, or any combination thereof for transmitting the downlink transmission.

### BRIEF DESCRIPTION OF THE DRAWINGS

FIG. 1 illustrates an example of a wireless communications system that supports reporting quantity of transmit antennas for wireless communications in accordance with one or more aspects of the present disclosure.

FIG. 2 illustrates an example of a network architecture that supports reporting quantity of transmit antennas for wireless communications in accordance with one or more aspects of the present disclosure.

FIG. 3 illustrates an example of a wireless communications system that supports reporting quantity of transmit antennas for wireless communications in accordance with one or more aspects of the present disclosure.

FIG. 4 illustrates an example of a process flow that supports reporting quantity of transmit antennas for wireless communications in accordance with one or more aspects of the present disclosure.

FIGS. 5 and 6 show block diagrams of devices that support reporting quantity of transmit antennas for wireless communications in accordance with one or more aspects of the present disclosure.

FIG. 7 shows a block diagram of a communications manager that supports reporting quantity of transmit antennas for wireless communications in accordance with one or more aspects of the present disclosure.

FIG. 8 shows a diagram of a system including a device that supports reporting quantity of transmit antennas for wireless communications in accordance with one or more aspects of the present disclosure.

FIGS. 9 and 10 show block diagrams of devices that support reporting quantity of transmit antennas for wireless communications in accordance with one or more aspects of the present disclosure.

FIG. 11 shows a block diagram of a communications manager that supports reporting quantity of transmit antennas for wireless communications in accordance with one or more aspects of the present disclosure.

FIG. 12 shows a diagram of a system including a device that supports reporting quantity of transmit antennas for wireless communications in accordance with one or more aspects of the present disclosure.

FIGS. 13 through 16 show flowcharts illustrating methods that support reporting quantity of transmit antennas for wireless communications in accordance with one or more aspects of the present disclosure.

### DETAILED DESCRIPTION

In some wireless communication systems, a UE may measure reference signals from a network entity to determine channel state information (CSI) parameters. The CSI parameters may include a modulation and coding scheme (MCS) supported by the UE, a rank (e.g., a quantity of beams) supported by the UE, a precoding matrix indicator (PMI), or any combination thereof. In some examples, the UE may transmit a CSI report that indicates the CSI parameters and the network entity may perform downlink transmissions to the UE in accordance with the reported CSI parameters. As such, the UE may determine a quantity of downlink beams (also referred to as spatial streams) that are used to transmit a given downlink message to the UE. However, the UE may not know a quantity of transmit antennas that the network entity may be using to transmit the downlink message to the UE.

Techniques described herein provide for the network entity to indicate the quantity of transmit antennas at the network entity used for transmitting a downlink message to the UE via control signaling. In some cases, the control signaling may be downlink control information (DCI), a radio resource control (RRC) configuration, or some other control signaling. The quantity of antennas indicated via the control signaling may correspond to a quantity of transmit antenna elements, arrays, or subarrays of an antenna panel at the network entity that may be activated for downlink transmissions to the UE. As such, the UE may use the indicated quantity of antennas to reduce power consumption and improve CSI reporting accuracy.

The UE may additionally, or alternatively, use the indicated quantity of transmit antennas to reduce complexity associated with demodulating the downlink transmissions, to improve CSI reporting accuracy, or both. For example, the UE may select a demodulator from among a plurality of demodulators at the UE based on the quantity of transmit antennas. In cases where the quantity of transmit antennas may be relatively high, the UE may select a demodulator associated with relatively low complexity to reduce power consumption while maintaining throughput. Additionally, or alternatively, the UE may calculate and report rank, MCS, or PMI based on the quantity of transmit antennas at the network entity, which may improve accuracy and reliability.
Aspects of the disclosure are initially described in the context of wireless communications systems. Additional aspects of the disclosure are described with reference to a wireless communication system and a process flow. Aspects of the disclosure are further illustrated by and described with reference to apparatus diagrams, system diagrams, and flowcharts that relate to reporting quantity of transmit antennas for wireless communications.

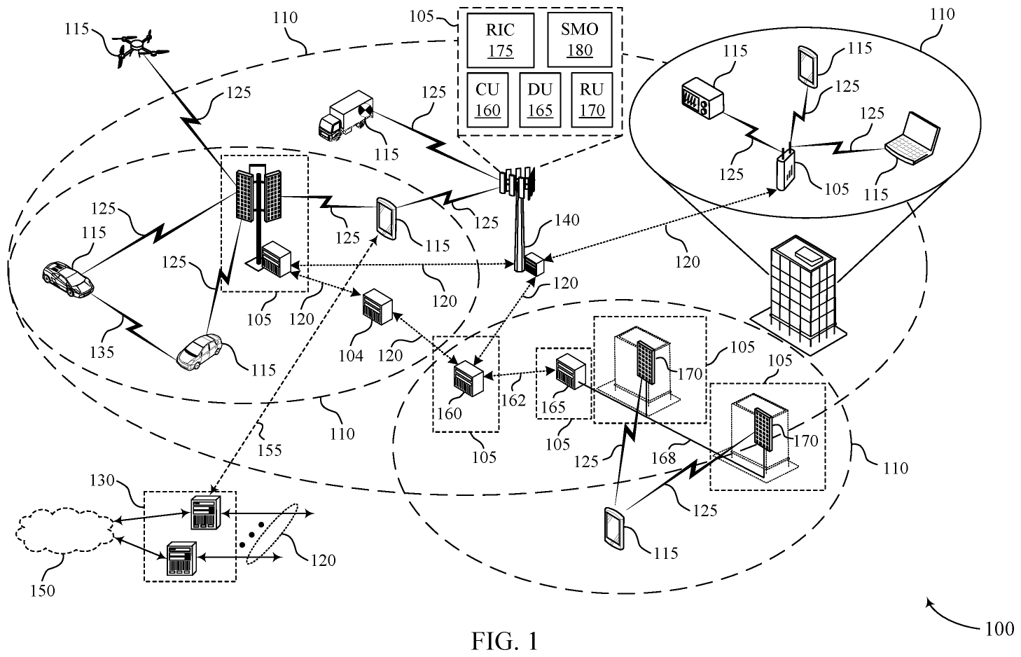

FIG. 1 illustrates an example of a wireless communications system 100 that supports reporting quantity of transmit antennas for wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support reporting quantity of transmit antennas for wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNB s or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communication system 100, a UE 115 may measure reference signals from a network entity 105 to determine CSI parameters. The CSI parameters may include a MCS supported by the UE 115, a rank (e.g., a quantity of beams) supported by the UE 115, a PMI, or any combination thereof. In some examples, the UE 115 may transmit a CSI report that indicates the CSI parameters and the network entity 105 may perform downlink transmissions to the UE 115 in accordance with the reported CSI parameters. As such, the UE 115 may determine a quantity of downlink beams (also referred to as spatial streams) that are used to transmit a given downlink message to the UE 115. However, the UE 115 may not know a quantity of transmit antennas that the network entity 105 may be using to transmit the downlink message to the UE.

Techniques described herein provide for the network entity 105 to indicate the quantity of transmit antennas at the network entity used for transmitting a downlink message to the UE via control signaling. In some cases, the control signaling may be DCI, RRC configuration, or some other control signaling. The quantity of transmit antennas indicated via the control signaling may correspond to a quantity of transmit antenna elements, arrays, or subarrays of an antenna panel at the network entity that may be activated for downlink transmissions to the UE 115. As such, the UE 115 may use the indicated quantity of antennas to reduce power consumption and improve CSI reporting accuracy.

The UE 115 may additionally, or alternatively, use the indicated quantity of transmit antennas to reduce complexity associated with demodulating the downlink transmissions, to improve CSI reporting accuracy, or both. For example, the UE 115 may select a demodulator from among a plurality of demodulators at the UE 115 based on the quantity of transmit antennas. In cases where the quantity may be relatively high, the UE 115 may select a demodulator associated with relatively low complexity to reduce power consumption while maintaining throughput. Additionally, or alternatively, the UE 115 may calculate and report the rank, MCS, or PMI based on the quantity of transmit antennas at the network entity 105, which may improve the accuracy and reliability of communications between the UE 115 and the network entity 105.

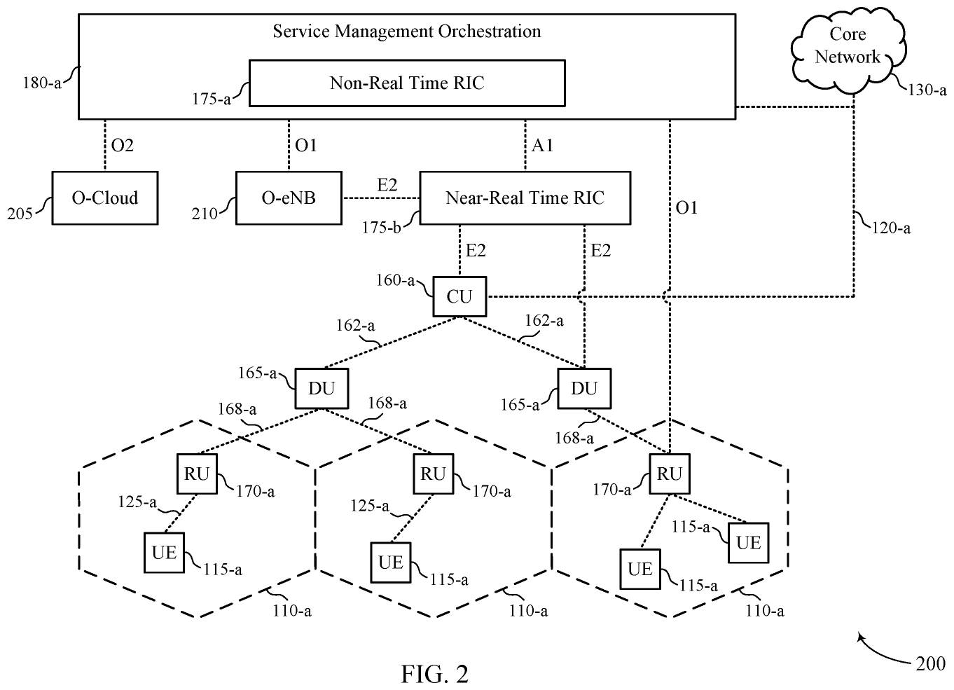

FIG. 2 illustrates an example of a network architecture 200 (e.g., a disaggregated base station architecture, a disaggregated RAN architecture) that supports reporting quantity of transmit antennas for wireless communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

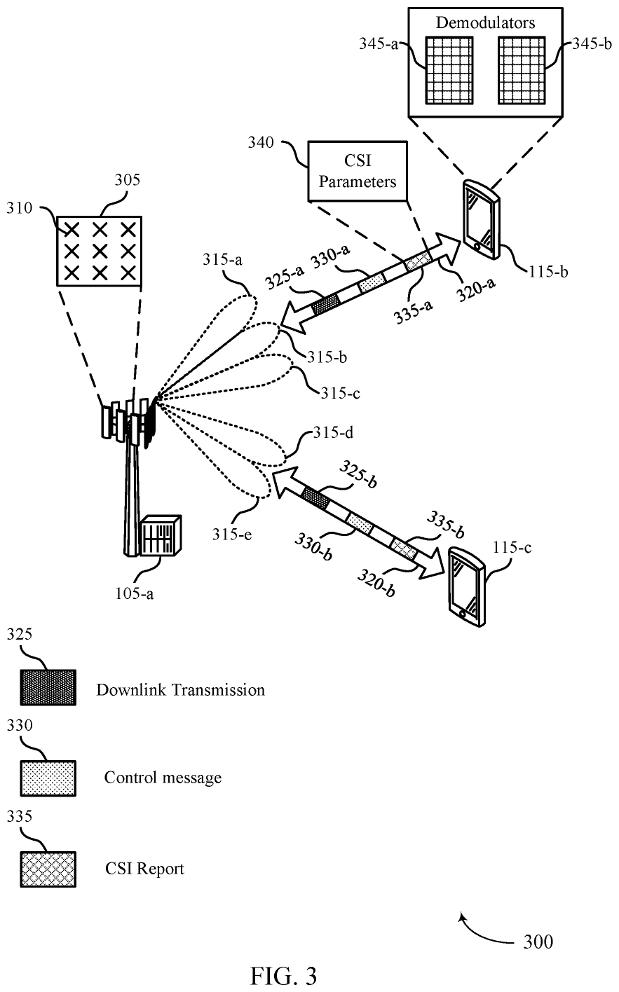

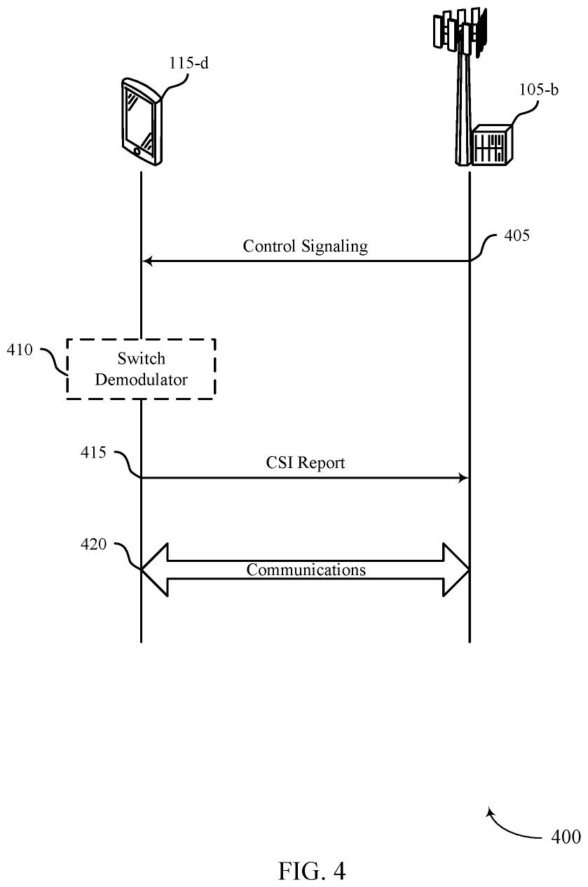

In some cases, the network architecture 200 may support techniques for a network entity 105 to transmit control signaling to a UE 115-a to indicate a quantity of transmit antenna that are activated for downlink communications with the UE 115-a. The quantity of transmit antennas may include antenna elements, antenna ports, antenna arrays, antenna subarrays, or some other types of antennas used by the network entity 105. The quantity of antennas may include antennas that are positioned on a same physical component of the network entity 105 (e.g., a same transmission/reception point (TRP)). Additionally, or alternatively, the quantity of antennas may be distributed across one or more TRPs, radio heads, or other components of the network entity 105. The UE 115-a may determine one or more CSI parameters (e.g., CSI, rank, PMI, MCS) based on the indicated quantity of transmit antennas, which may improve accuracy and reliability of the selected and reported CSI parameters and corresponding communications. In some examples, the UE 115-a may select a demodulator from among multiple demodulators at the UE 115-a based on the indicated quantity of antennas. The UE 115-a may thereby reduce power consumption while maintaining throughput and reliability of communications. Techniques and methods for the network entity 105 to indicate a quantity of transmit antennas are described in further detail elsewhere herein, with reference to FIGS. 3 and 4.

FIG. 3 illustrates an example of a wireless communications system 300 that supports reporting quantity of transmit antennas for wireless communications in accordance with one or more aspects of the present disclosure. In some examples, the wireless communications system 300 may implement or be implemented by aspects of the wireless communications system 100 or the network architecture 200, as described with reference to FIGS. 1 and 2. For example, the wireless communications system 300 may include a UE 115-b, a UE 115-c, and a network entity 105-a, which may represent examples of corresponding devices described herein. In this example, the network entity 105-a may transmit an indication of a quantity of antennas at the network entity 105-a, which may improve communication reliability and coordination between devices in the wireless communications system 300.

The network entity 105-a may include an antenna panel 305. The antenna panel 305 may include one or more antennas 310. The antennas 310 may be combined into an antenna array or a subarray of the antenna panel 305. For example, one or more of the antennas 310 may be an example of a section within the antenna panel 305, such as a subarray or an array of antennas 310. The antennas 310 may be used by the network entity 105-a for transmission, reception, or both of wireless communications. Each of the antennas 310 illustrated in FIG. 3 may represent an example of an antenna element, an antenna port, a group of antenna elements, an array of antenna elements, a subarray of antenna elements, or any combination thereof, and may be referred to as transmit antennas 310 in some aspects described herein.

The network entity 105-a may transmit and receive wireless communications using the antennas 310 within the antenna panel 305. When the network entity 105-a transmits a downlink transmission 325, the antennas 310 of the antenna panel 305 may be used to generate or produce one or more beams 315 (e.g., spatial streams), such as the beams 315-a, 315-b, 315-c, 315-d, and 315-e. In some examples, a single antenna 310 may produce a single corresponding beam 315, or multiple antennas 310 may produce a single beam 315, or any quantity of antennas 310 may be used to produce a single beam 315. The beams 315 may, in some examples, be examples of spatial streams. For example, the antennas 310 at the network entity may produce or generate separately coded data signals, which may be referred to as spatial streams. As such, the network entity 105-a may communicate with the UEs 115-b and 115-c via the communication links 320-a and 320-b, respectively, using one or more sets of beams 315.

In some examples, the network entity 105-a may use different sets of beams 315 to communicate with different devices. For example, the network entity 105-a may use a first set of beams 315 including the beams 315-a, 315-b, and 315-c, for communications with the UE 115-b via the communication link 320-a and the network entity 105-a may use a second set of beams 315 including the beams 315-d and 315-e, for communications with the UE 115-c via the communication link 320-b. To perform communications with the network entity 105-a, the UEs 115-a and 115-b may know or be aware of a quantity of the beams 315 that are used for the communications. For example, the UE 115-b may receive a message (e.g., an RRC configuration, or some other control message) that indicates how many beams 315 (e.g., spatial streams) will be used for receiving the downlink transmission 325-a (e.g., three in the example of FIG. 3). The UEs 115 may receive and measure downlink transmissions 325 based on the quantity of beams 315 to determine CSI parameters 340 for a CSI report 335. In some cases, however, the UEs 115 may not know the quantity of antennas 310 that are used by the network entity 105-a for communications.

Techniques, systems, and devices described herein provide for the network entity 105-a to indicate, to a UE 115, a quantity of antennas 310 at the network entity 105-a that are activated for a downlink transmission 325 to the UE 115. The UE 115 may use the indicated quantity of antennas 310 to improve estimation or calculation of CSI parameters 340, improve demodulation by the UE 115, or both. The network entity 105-a may indicate the quantity of antennas 310 via control signaling 330 (e.g., control signaling 330-a or control signaling 330-b). The control signaling may include, for example, one or more DCI messages, one or more RRC messages, other types of control messages, or any combination thereof. The control signaling 330 may include one or more bits within a field configured to indicate the quantity of antennas 310.

The quantity of antennas 310 indicated via the control signaling 330 to a given UE 115 may indicate transmit antennas 310 that are activated for a downlink transmission 325 to that respective UE 115. The network entity 105-a may utilize different sets of antennas 310 for communications with different devices. For example, the network entity 105-a may utilize a first set of one or more antennas 310 of the antenna panel 305 and corresponding beams 315 to transmit the downlink transmission 325-a to the UE 115-b (e.g., and one or more other UEs 115 included in a same UE group or sector) and the network entity 105-a may utilize a second set of one or more antennas 310 of the antenna panel 305 and corresponding beams 315 to transmit the downlink transmission 325-b to the UE 115-c (e.g., and one or more other UEs 115 included in a same UE group or sector). Thus, the control signaling 330-a transmitted to the UE 115-b may indicate a quantity of antennas 310 from the first set that are activated and the control signaling 330-b transmitted to the UE 115-c may indicate a quantity of antennas 310 from the second set that are activated.

In some examples, the network entity 105-a may transmit the control signaling 330 periodically during communications with a UE 115. For example, after establishing a connection with the UE 115-b, the network entity 105-a may transmit two or more DCI messages to the UE 115-b in accordance with a configured periodicity to indicate a quantity of antennas 310 that are activated at the network entity 105-a. The quantity of antennas 310 may be the same over time or may change dynamically, such that each periodic message may indicate a same or different quantity. Additionally, or alternatively, the network entity 105-a may transmit the control signaling 330 dynamically in response to a trigger. The trigger may be, for example, a change in the quantity of antenna 310 that are activated at the network entity 105-a, or some other trigger (e.g., a change in a communication parameter, or the like). In such cases, each control message transmitted by the network entity 105-a may indicate an updated (e.g., different, new) quantity of antenna 310 that are activated. The network entity 105-a may thereby transmit the control signaling 330 periodically, aperiodically, or semi-statically.

A UE 115 as described herein (e.g., the UE 115-b or the UE 115-c) may receive the control signaling 330 and use the indicated quantity of antennas 310 to determine communication parameters, which may improve accuracy, coordination between devices, and communication reliability, among other examples. For example, the UE 115-b may determine (e.g., generate, select, adapt) CSI parameters 340 based on the quantity of antennas 310 indicated via the control signaling 330-a. The CSI parameters 340 may include a CSI rank (e.g., a quantity of spatial streams or beams 315) for communications, a PMI for communications, an MCS for communications, one or more other CSI parameters 340, or any combination thereof.

Values of each of the CSI parameters may be correlated to the quantity of antennas 310 at the network entity 105-a. As such, if the UE 115-b knows the quantity of antennas 310 of the antenna panel 305 that are going to be used for the downlink transmission 325-a, the UE 115-b may more accurately select or calculate the rank, PMI, or MCS for communications with the network entity 105-a. The MCS complexity, for example, may be inversely related to the quantity of antennas 310. For example, the UE 115-b may choose a less complex MCS if the quantity of antennas 310 is relatively large, or alternatively, the UE 115-b may choose a more complex MCS if the quantity of antennas 310 is relatively small. A more complex MCS may improve communication reliability, but may increase power consumption. Thus, by balancing the complexity of the MCS with the quantity of transmit antennas 310 at the network entity 105-a, the UE 115-b may determine an adequate trade-off between power consumption and communication reliability. The rank and PMI that the UE 115-b may support while still reliably decoding a downlink transmission 325 may increase proportionally as the quantity of transmit antennas 310 used at the network entity 105-a increases. Thus, the UE 115-b may select CSI parameters 340 that are more or less aggressive based on the indicated quantity of transmit antennas 310, which may improve efficiency while maintaining reliable communications.

In some examples, the UE 115-b may use the quantity of antenna 310 to reduce demodulation complexity associated with demodulating and decoding the downlink transmission 325-a. The UE 115-b may include one or more demodulators 345, including at least a first demodulator 345-a and a second demodulator 345-b. The UE 115-b may use at least one of the demodulators 345 to demodulate each downlink transmission 325 received by the UE 115-b. The demodulators 345 may each be associated with a respective demodulation complexity. For example, the demodulator 345-a may correspond to a first complexity and the demodulator 345-b may correspond to a second complexity. In some examples, the second complexity may be associated with a relatively lower complexity than the first complexity. As demodulator complexity increases, an accuracy or reliability of the demodulation may increase, and power consumption may also increase.

The UE 115-b may compare the quantity of antennas 310 at the network entity 105-a with a rank of a downlink transmission 325 to determine which demodulator 345 to use for demodulating the downlink transmission 325. In some examples, the quantity of antennas 310 being used at the network entity 105-a may be larger than a rank of the downlink transmission 325 (e.g., N TX>>Rank). The rank of the downlink transmission 325 may correspond to a quantity of spatial streams being used for the downlink transmission 325, which may indicate that the beams 315 generated by the network entity 105-a may be relatively more precise. Such a relationship between a relatively low rank and a relatively high quantity of transmit antennas 310 may be associated with a relatively low spatial correlation between the spatial streams and relatively low inter stream interference (ISI). As such, this correlation may provide for the UE 115-b to select a relatively low complexity demodulator 345 (e.g., a demodulator 345 that is not capable of mitigating the ISI, such as a demodulator 345 using a minimum mean square error (MMSE) model) to reduce power consumption while maintaining demodulation accuracy and reliability.

In some implementations, the UE 115-b may detect that the quantity of antennas 310 activated at the network entity 105-a for the downlink transmission 325-a may be greater than the quantity of spatial streams (e.g., beams 315) associated with the downlink transmission 325-a by at least a threshold quantity or a threshold ratio. The threshold may be configured at the UE 115-b or indicated to the UE 115-b via a control message. In such cases, the UE 115-b may select a demodulator 345 with a relatively low demodulation complexity. In one example, the threshold ratio may be equal to 2:1, and a ratio of antennas 310 to beams 315 for the downlink transmission 325-a may be 3:1. The ratio of the quantity of antennas 310 to the quantity of beams 315 of the UE 115-b may be greater than the threshold ratio value (e.g., 3:1>2:1), which may trigger the UE 115-b to select a less complex demodulator 345. For example, the UE 115-b may switch from the first demodulator 345-a associated with the first complexity to the second demodulator 345-b associated with the second complexity based on the second complexity being less complex than the first complexity. In some cases, the threshold ratio or quantity for selection of a demodulator 345 may be preconfigured when communications between the network entity 105-a and the UE 115-b are initiated or the thresholds may be transmitted in the control signaling 330 from the network entity 105-a to the UE 115-b.

In one example, 20 antennas 310 (e.g., or some other quantity of antennas 310) may be activated at the network entity 105-a and three spatial streams may be used for the downlink transmission 325-a. The UE 115-b may detect such a relationship between rank and antennas 310, and the UE 115-b may switch from using the demodulator 345-a to using the demodulator 345-b, which may be associated with a relatively lower complexity than the demodulator 345-a. The UE 115-b may thereby reduce power consumption, processing complexity, and latency while maintaining communication and demodulation reliability and accuracy.

In some cases, the performance and accuracy of measurements to determine the values of the CSI parameters 340 may increase based on the network entity 105-a indicating a quantity of antennas 310 activated at the network entity 105-a for communications with the UE 115-b. For example, if the network entity 105-a indicates the quantity of transmit antennas 310 to the UE 115-b, but the network entity 105-a does not indicate the quantity of transmit antennas 310 to the UE 115-c, the CSI report 335 generated by the UE 115-b may be more accurate than a CSI report generated by the UE 115-c because the UE 115-b may use the knowledge of the quantity of transmit antennas 310 when generating the CSI report 335. The quantity of antennas 310 and a corresponding quantity of beams 315 generated by the network entity 105-a may affect channel parameters, including the CSI parameters 340. For example, the beams 315 may be related to different directions and coverage areas from the network entity 105-a. As such, the increase in the quantity of antennas 310 and beams 315 may improve throughput as the network entity 105-a may support an increased quantity of directions for communicating with the UE 115-b. An increase in the quantity of antennas 310, the quantity of beams 315, or both, may improve communication reliability, even if a position, speed, and velocity of the UE 115-b changes dynamically. For example, if the network entity 105-a supports a relatively large coverage area in various different directions due to an increase in the quantity of antennas 310 and the quantity of beams 315, the UE 115-b may be able to receive messages and synchronization from the network entity 105-a, which may include the control signaling 330-a, while changing positions and speed more reliably that if the quantity of antennas 310, the quantity of beams 315, or both are reduced. Thus, the UE 115-b may select CSI parameters based on the quantity of antennas 310 at the network entity 105-a, which may improve CSI reporting accuracy.

The UEs 115 described herein may thereby receive control signaling 330 that indicates a quantity of transmit antennas 310 activated at the network entity 105-a, and the UEs 115 may use the indicated value of the quantity of antennas 310 to support reduced power consumption and increased power savings at the UEs 115 while maintaining or increasing spectral efficiency. Spectral efficiency may relate to an amount of data transmitted in a given spectrum or frequency bandwidth. As such, if the UE 115-b determines that there may be a relatively large quantity of antennas 310 for transmissions by the network entity 105-a as compared to the quantity of spatial streams being used for the downlink transmission 325-a (e.g., more than the threshold quantity or the threshold ratio), the UE 115-b may determine that the spectral efficiency may be maintained using a lower complexity demodulator 345 while maintaining throughput and demodulation reliability due to the quantity of antennas 310 being used for the downlink transmission 325-a. As such, the UE 115-b may switch from a higher complexity demodulator (e.g., the first demodulator 345-a) to a lower complexity demodulator (e.g., the second demodulator 345-b), which may reduce the power consumption of the UE 115-b without reducing the spectral efficiency.

As such, the techniques described herein may support the network entity 105-a transmitting control signaling 330 to the UEs 115 to indicate a quantity of antennas 310 of an antenna panel 305 that are activated for a downlink transmission 325. Such control signaling 330 may support reduced power consumption and increased power saving efforts while maintaining spectral efficiency of communications for communications.

FIG. 4 illustrates an example of a process flow 400 that supports reporting quantity of transmit antennas for wireless communications in accordance with one or more aspects of the present disclosure. In some examples, the process flow 400 may implement or be implemented by aspects of the wireless communications systems 100 or 300 or the network architecture 200, as described with reference to FIGS. 1-3. For example, the process flow 400 may include a UE 115-d and a network entity 105-b which may be examples of a UE 115 and a network entity 105 as described with reference to FIGS. 1-3. In this example, the network entity 105-b may indicate, to the UE 115-d, a quantity of transmit antennas that are activated at the network entity 105-b, which may improve communication reliability and coordination between devices.

In the following description of the process flow 400, the operations between the UE 115-d and the network entity 105-b may be performed in different orders or at different times. Some operations may also be left out of the process flow 400, or other operations may be added. Although the UE 115-d and the network entity 105-b are shown performing the operations of the process flow 400, some aspects of some operations may also be performed by one or more other wireless devices.

At 405, the UE 115-d may receive, from the network entity 105-b, control signaling indicating a quantity of transmit antennas at the network entity 105-b. The quantity of transmit antennas may include antennas that may be activated for downlink transmissions to the UE 115-d. In some examples, the UE 115-d may receive multiple control messages as part of the control signaling received at 405. A first control message may indicate the quantity of transmit antennas that may be activated at the network entity 105-b at a first time, and one or more of the other control messages may indicate one or more other quantities of transmit antennas that may be activated at the network entity 105-b at one or more other times different than the first time. For example, the network entity 105-b may transmit the control messages periodically or aperiodically (e.g., based on a trigger, such as a change in the quantity of transmit antennas), and each control message may indicate a respective quantity of transmit antennas that may be activated at the network entity 105-b for a respective time period associated with the periodicity or the timing of the control messages. The control messages may include DCI messages, RRC configurations, some other type of control message, or any combination thereof.

At 410, in some examples, the UE 115-d may switch from a first demodulator of the UE 115-d to a second demodulator of the UE 115-d based on the quantity of transmit antennas indicated via the control signaling. In some examples, the UE 115-d may identify a quantity of spatial streams associated with the downlink transmission. As described with reference to FIG. 3, the spatial streams may correspond to or represent examples of beams or streams of energy or signaling generated by the antennas of an antenna panel at the network entity 105-b. As such, the quantity of spatial streams may be associated with the quantity of transmit antennas activated at the network entity 105-b for communications with the UE 115-d. The beams may be further described elsewhere herein, including with reference to FIG. 3. The UE 115-d may include multiple demodulators, as described with reference to FIG. 3. The UE 115-d may select the second demodulator from the multiple demodulators of the UE 115-d for demodulation of the downlink transmission based on the relationship between the quantity of transmit antennas and the quantity of spatial streams associated with the downlink transmission.

In some examples, each demodulator of a quantity of demodulators of the UE 115-d may be associated with a respective demodulation complexity. The UE 115-d may determine that the indicated quantity of transmit antennas may be greater than a quantity of spatial streams associated with the downlink transmission by at least a threshold quantity or threshold ratio. In such cases, the UE 115-d may select the second demodulator associated with a second complexity that correlates with a relatively lower complexity than a first complexity associated with the first demodulator and one or more other complexities associated with one or more other demodulators of the quantity of demodulators based on determining the indicated quantity of transmit antennas is greater than a quantity of spatial streams by at least the threshold. The UE 115-d may switch from the first demodulator to the second demodulator based on selecting the second demodulator.

At 415, the UE 115-d may transmit, to the network entity 105-b, a CSI report including a set of one or more CSI parameters. The set of one or more CSI parameters may be based on the quantity of transmit antennas at the network entity 105-b indicated via the control signaling. The set of one or more CSI parameters may include a PMI, a rank, an MCS, one or more other CSI parameters, or any combination thereof for receiving the downlink transmission. In some cases, the UE 115-d may determine the set of one or more CSI parameters based on the indicated quantity of transmit antennas at the network entity 105-b and one or more conditions at the UE 115-d, such as a position of the UE 115-d, a velocity or speed of the UE 115-d, one or more other conditions of the UE 115-d, or any combination thereof. In some examples, a value of each CSI parameter of the set of one or more CSI parameters may be correlated to quantity of transmit antennas at the network entity 105-b.

At 420, the UE 115-d may communicate with the network entity 105-b based on the set of one or more CSI parameters indicated via the CSI report. For example, the UE 115-d may receive downlink transmissions, transmit uplink transmissions, or both, in accordance with the CSI parameters and the demodulator selected by the UE 115-d.

In some examples, the UE 115-d may detect a change in one or more parameters associated with the communications between the UE 115-d and the network entity 105-b. In such cases, if the communication parameters change more than a threshold amount (e.g., or within a threshold time period), the UE 115-d may transmit a second CSI report to indicate a second set of one or more CSI parameters in response to detecting the change. For example, the UE 115-d may apply a backoff. In some examples, a difference between the set of one or more CSI parameters indicated via the first CSI report and the second set of one or more CSI parameters (e.g., the amount of backoff applied by the UE 115-d) may be based on the indicated quantity on antennas at the network entity and the change in the one or more communication parameters. That is, the UE 115-d may reduce an amount of backoff applied by the UE 115-d if the quantity of transmit antennas that are activated at the network entity 105-b is relatively high or may increase an amount of backoff applied by the UE 115-d if the quantity of transmit antennas that are activated at the network entity 105-b is relatively low. The network entity 105-b may transmit a second downlink transmission based on the second set of one or more CSI parameters indicated via the second CSI report.

The network entity 105-b and the UE 115-d described herein may thereby reduce power consumption, increase power savings, and improve CSI reporting accuracy by exchanging information indicative of the quantity of transmit antennas used for a downlink transmission. This information may support the UE 115-d to more accurately select and calculate the set of one or more CSI parameters and may support the network entity 105-b in increasing the accuracy of the communications between the network entity 105-b and the UE 115-d.

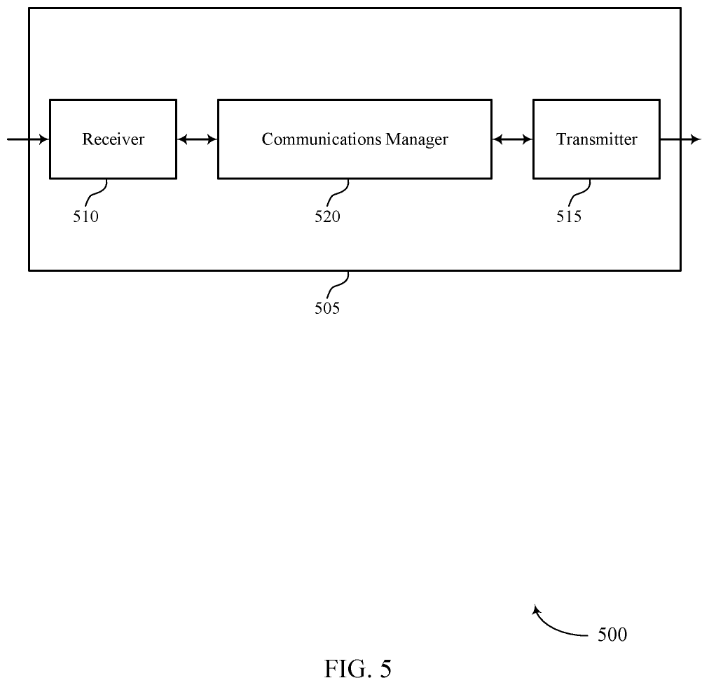

FIG. 5 shows a block diagram 500 of a device 505 that supports reporting quantity of transmit antennas for wireless communications in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to reporting quantity of transmit antennas for wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to reporting quantity of transmit antennas for wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of reporting quantity of transmit antennas for wireless communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

Additionally, or alternatively, the communications manager 520 may support wireless communication at a UE in accordance with examples as disclosed herein. For example, the communications manager 520 may be configured as or otherwise support a means for receiving control signaling that indicates a quantity of transmit antennas at a network entity, the quantity of transmit antennas including antennas that are activated for a downlink transmission to the UE. The communications manager 520 may be configured as or otherwise support a means for transmitting a CSI report including a set of one or more CSI parameters, the set of one or more CSI parameters based on the indicated quantity of transmit antennas at the network entity. The communications manager 520 may be configured as or otherwise support a means for communicating with the network entity based on the set of one or more CSI parameters indicated via the CSI report.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption, and increased power savings.

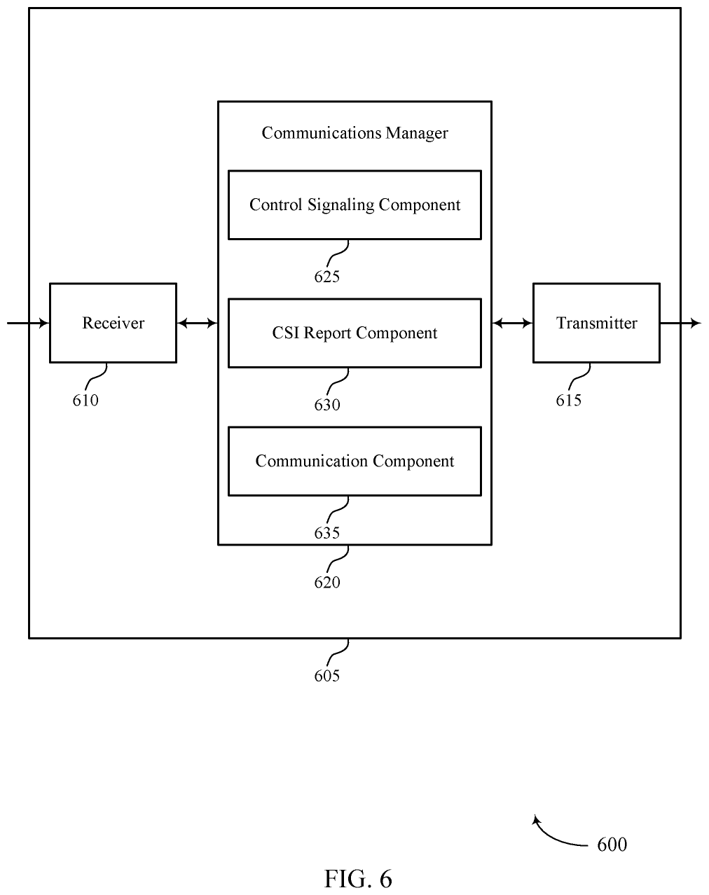

FIG. 6 shows a block diagram 600 of a device 605 that supports reporting quantity of transmit antennas for wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to reporting quantity of transmit antennas for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reporting quantity of transmit antennas for wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of reporting quantity of transmit antennas for wireless communications as described herein. For example, the communications manager 620 may include a control signaling component 625, a CSI report component 630, a communication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The control signaling component 625 may be configured as or otherwise support a means for receiving control signaling that indicates a quantity of transmit antennas at a network entity, the quantity of transmit antennas including antennas that are activated for a downlink transmission to the UE. The CSI report component 630 may be configured as or otherwise support a means for transmitting a CSI report including a set of one or more CSI parameters, the set of one or more CSI parameters based on the indicated quantity of transmit antennas at the network entity. The communication component 635 may be configured as or otherwise support a means for communicating with the network entity based on the set of one or more CSI parameters indicated via the CSI report.

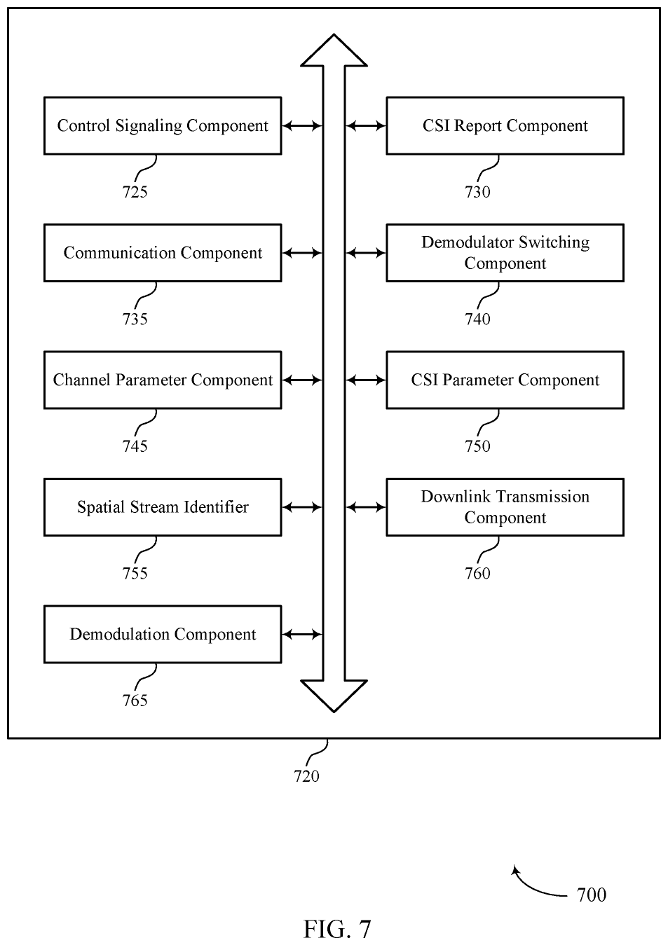

FIG. 7 shows a block diagram 700 of a communications manager 720 that supports reporting quantity of transmit antennas for wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of reporting quantity of transmit antennas for wireless communications as described herein. For example, the communications manager 720 may include a control signaling component 725, a CSI report component 730, a communication component 735, a demodulator switching component 740, a channel parameter component 745, a CSI parameter component 750, a spatial stream identifier 755, a downlink transmission component 760, a demodulation component 765, or any combination thereof. Each of these components may communicate, directly or indirectly, with one another (e.g., via one or more buses).

Additionally, or alternatively, the communications manager 720 may support wireless communication at a UE in accordance with examples as disclosed herein. The control signaling component 725 may be configured as or otherwise support a means for receiving control signaling that indicates a quantity of transmit antennas at a network entity, the quantity of transmit antennas including antennas that are activated for a downlink transmission to the UE. The CSI report component 730 may be configured as or otherwise support a means for transmitting a CSI report including a set of one or more CSI parameters, the set of one or more CSI parameters based on the indicated quantity of transmit antennas at the network entity. The communication component 735 may be configured as or otherwise support a means for communicating with the network entity based on the set of one or more CSI parameters indicated via the CSI report.

In some examples, to support receiving the control signaling, the control signaling component 725 may be configured as or otherwise support a means for receiving a set of multiple control messages, where a first control message of the set of multiple control messages indicates the quantity of transmit antennas that are activated at the network entity at a first time, and where one or more other control messages of the set of multiple control messages indicate one or more other quantities of transmit antennas that are activated at the network entity at one or more other times different than the first time.

In some examples, to support receiving the set of multiple control messages, the control signaling component 725 may be configured as or otherwise support a means for receiving the set of multiple control messages periodically, where each of the set of multiple control messages indicates a respective quantity of transmit antennas that are activated at the network entity for a respective time period associated with a periodicity of the set of multiple control messages.

In some examples, to support receiving the set of multiple control messages, the control signaling component 725 may be configured as or otherwise support a means for receiving the set of multiple control messages aperiodic ally or periodically, where one or more the set of multiple control messages indicates a respective change in the quantity of transmit antennas that are activated at the network entity.

In some examples, to support receiving the control signaling, the control signaling component 725 may be configured as or otherwise support a means for receiving DCI that indicates the quantity of transmit antennas.

In some examples, to support receiving the control signaling, the control signaling component 725 may be configured as or otherwise support a means for receiving RRC signaling that indicates the quantity of transmit antennas.

In some examples, the demodulator switching component 740 may be configured as or otherwise support a means for switching from a first demodulator of a set of multiple demodulators of the UE to a second demodulator of the set of multiple demodulators based on the indicated quantity of transmit antennas.

In some examples, the spatial stream identifier 755 may be configured as or otherwise support a means for identifying a quantity of spatial streams associated with the downlink transmission. In some examples, the demodulator switching component 740 may be configured as or otherwise support a means for selecting the second demodulator from among the set of multiple demodulators of the UE to use for demodulating the downlink transmission based on a relationship between the indicated quantity of transmit antennas and the quantity of spatial streams associated with the downlink transmission, where switching from the first demodulator to the second demodulator is based on selecting the second demodulator. In some examples, the downlink transmission component 760 may be configured as or otherwise support a means for receiving the downlink transmission. In some examples, the demodulation component 765 may be configured as or otherwise support a means for demodulating the downlink transmission using the selected demodulator.

In some examples, each demodulator of the set of multiple demodulators of the UE is associated with a respective demodulation complexity, and the spatial stream identifier 755 may be configured as or otherwise support a means for determining that the indicated quantity of transmit antennas is greater than a quantity of spatial streams associated with the downlink transmission by at least a threshold quantity or threshold ratio. In some examples, each demodulator of the set of multiple demodulators of the UE is associated with a respective demodulation complexity, and the demodulator switching component 740 may be configured as or otherwise support a means for selecting the second demodulator associated with a second complexity that is less than a first complexity associated with the first demodulator and one or more other complexities associated with one or more other demodulators of the set of multiple demodulators based on the determining, where switching from the first demodulator to the second demodulator is based on selecting the second demodulator.

In some examples, the channel parameter component 745 may be configured as or otherwise support a means for detecting a change in one or more channel parameters associated with communications between the UE and the network entity. In some examples, the CSI report component 730 may be configured as or otherwise support a means for transmitting a second CSI report to indicate a second set of one or more CSI parameters in response to detecting the change, where a difference between the set of one or more CSI parameters and the second set of one or more CSI parameters is based on the indicated quantity of antennas at the network entity and the change in the one or more channel parameters.

In some examples, the CSI parameter component 750 may be configured as or otherwise support a means for determining the set of one or more CSI parameters based on conditions at the UE and the indicated quantity of transmit antennas at the network entity, where a value of each CSI parameter of the set of one or more CSI parameters is correlated to the quantity of transmit antennas at the network entity.

In some examples, the set of one or more CSI parameters includes a PMI, a rank, a MCS, or any combination thereof for receiving the downlink transmission.

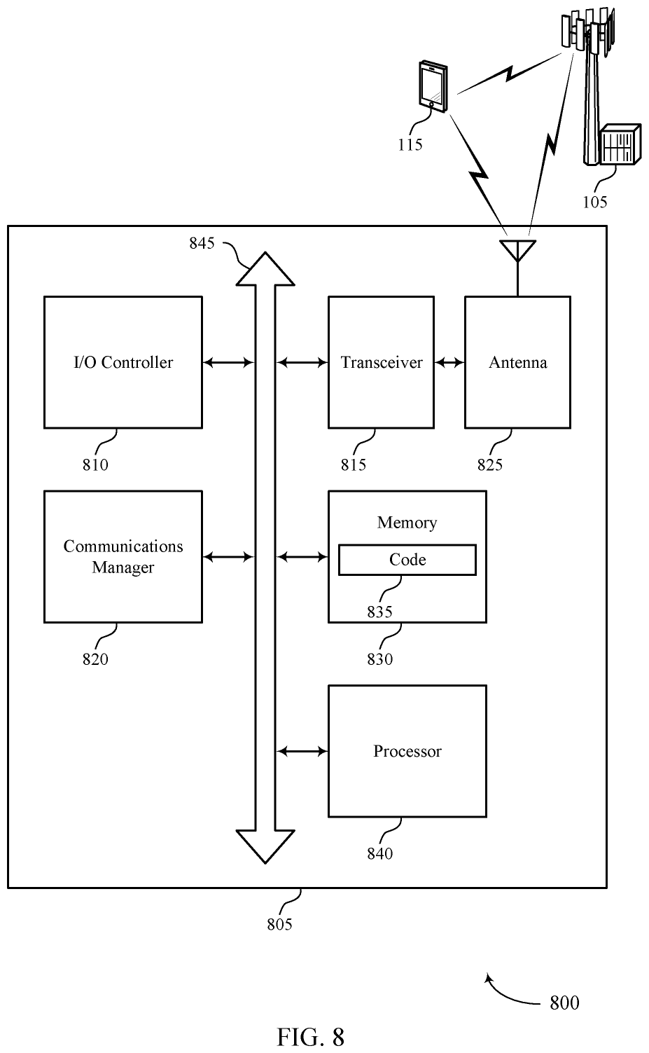

FIG. 8 shows a diagram of a system 800 including a device 805 that supports reporting quantity of transmit antennas for wireless communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting reporting quantity of transmit antennas for wireless communications). For example, the device 805 or a component of the device 805 may include a processor 840 and memory 830 coupled with or to the processor 840, the processor 840 and memory 830 configured to perform various functions described herein.

Additionally, or alternatively, the communications manager 820 may support wireless communication at a UE in accordance with examples as disclosed herein. For example, the communications manager 820 may be configured as or otherwise support a means for receiving control signaling that indicates a quantity of transmit antennas at a network entity, the quantity of transmit antennas including antennas that are activated for a downlink transmission to the UE. The communications manager 820 may be configured as or otherwise support a means for transmitting a CSI report including a set of one or more CSI parameters, the set of one or more CSI parameters based on the indicated quantity of transmit antennas at the network entity. The communications manager 820 may be configured as or otherwise support a means for communicating with the network entity based on the set of one or more CSI parameters indicated via the CSI report.

By including or configuring the communications manager 820 in accordance with examples as described herein, the device 805 may support techniques for improved communication reliability, reduced latency, improved user experience related to reduced processing, reduced power consumption improved coordination between devices, and longer battery life. For example, by receiving an indication of a quantity of transmit antennas that are activated at a network entity, the device 805 (e.g., a UE) may improve accuracy of CSI parameter selection, which may improve throughput and communication reliability. Additionally, or alternatively, the device 805 may use the indicated quantity of transmit antennas to select and switch from a first demodulator to a second demodulator that may be associated with a relatively lower or higher complexity than the complexity of the first demodulator. Selection of demodulation complexity based on transmit antenna quantities may support reduced power consumption, reduced processing, and longer battery life of the device 805 by using fewer computational resources of the device 805 to maintain reliable and accurate communications.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of reporting quantity of transmit antennas for wireless communications as described herein, or the processor 840 and the memory 830 may be otherwise configured to perform or support such operations.

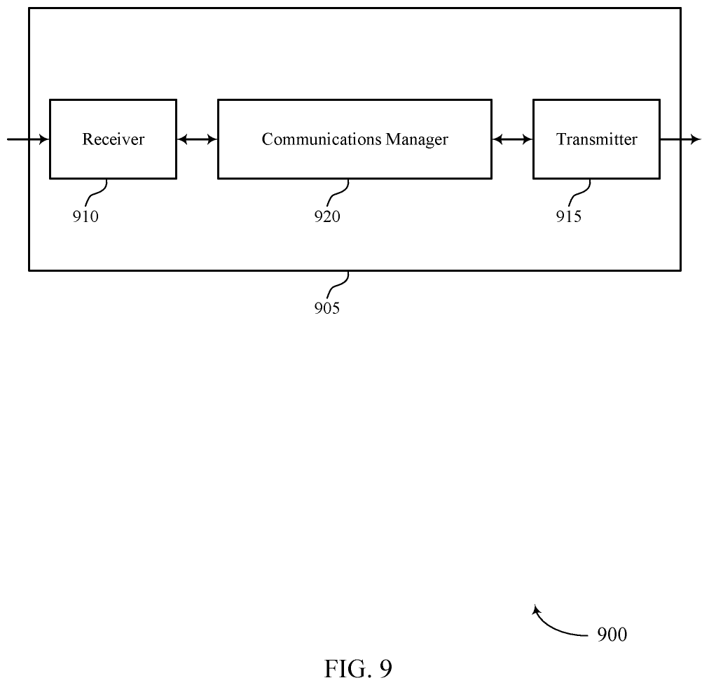

FIG. 9 shows a block diagram 900 of a device 905 that supports reporting quantity of transmit antennas for wireless communications in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of reporting quantity of transmit antennas for wireless communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communication at a network entity in accordance with examples as disclosed herein. For example, the communications manager 920 may be configured as or otherwise support a means for transmitting control signaling that indicates a quantity of transmit antennas at the network entity, the quantity of transmit antennas including antennas that are activated for a downlink transmission to a UE. The communications manager 920 may be configured as or otherwise support a means for receiving a CSI report including a set of one or more CSI parameters, the set of one or more CSI parameters based on the indicated quantity of transmit antennas at the network entity. The communications manager 920 may be configured as or otherwise support a means for communicating with the UE based on the set of one or more CSI parameters indicated via the CSI report.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption, reduced processing, and increased power savings.

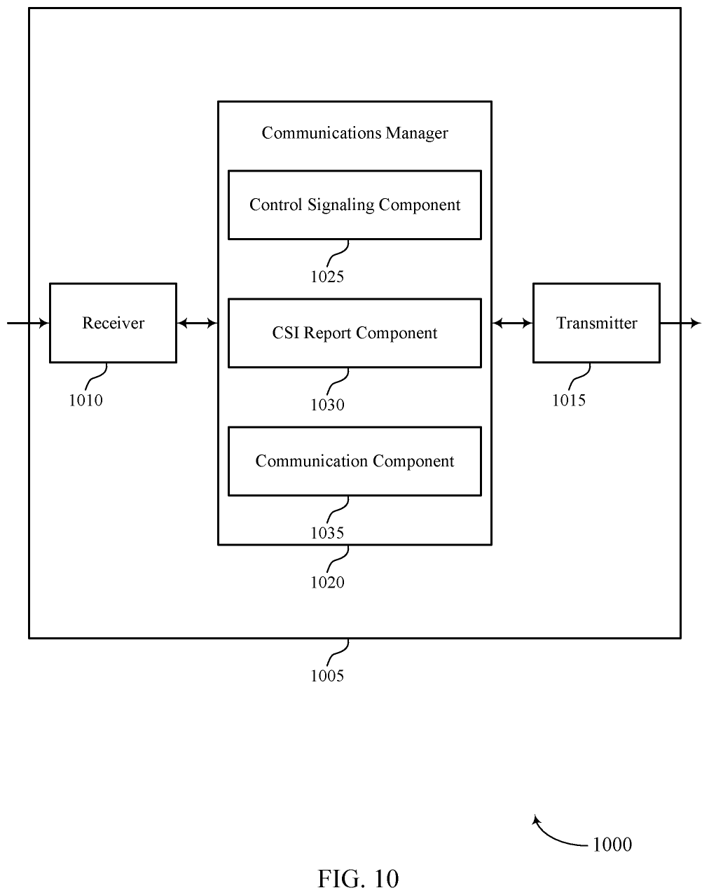

FIG. 10 shows a block diagram 1000 of a device 1005 that supports reporting quantity of transmit antennas for wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of reporting quantity of transmit antennas for wireless communications as described herein. For example, the communications manager 1020 may include a control signaling component 1025, a CSI report component 1030, a communication component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The control signaling component 1025 may be configured as or otherwise support a means for transmitting control signaling that indicates a quantity of transmit antennas at the network entity, the quantity of transmit antennas including antennas that are activated for a downlink transmission to a UE. The CSI report component 1030 may be configured as or otherwise support a means for receiving a CSI report including a set of one or more CSI parameters, the set of one or more CSI parameters based on the indicated quantity of transmit antennas at the network entity. The communication component 1035 may be configured as or otherwise support a means for communicating with the UE based on the set of one or more CSI parameters indicated via the CSI report.

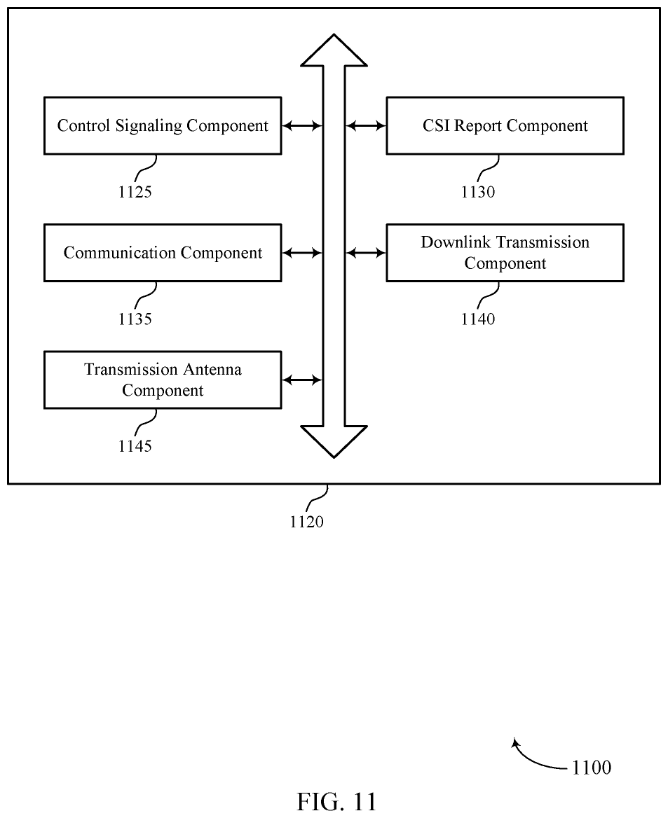

FIG. 11 shows a block diagram 1100 of a communications manager 1120 that supports reporting quantity of transmit antennas for wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of reporting quantity of transmit antennas for wireless communications as described herein. For example, the communications manager 1120 may include a control signaling component 1125, a CSI report component 1130, a communication component 1135, a downlink transmission component 1140, a transmission antenna component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1120 may support wireless communication at a network entity in accordance with examples as disclosed herein. The control signaling component 1125 may be configured as or otherwise support a means for transmitting control signaling that indicates a quantity of transmit antennas at the network entity, the quantity of transmit antennas including antennas that are activated for a downlink transmission to a UE. The CSI report component 1130 may be configured as or otherwise support a means for receiving a CSI report including a set of one or more CSI parameters, the set of one or more CSI parameters based on the indicated quantity of transmit antennas at the network entity. The communication component 1135 may be configured as or otherwise support a means for communicating with the UE based on the set of one or more CSI parameters indicated via the CSI report.

In some examples, to support transmitting the control signaling, the control signaling component 1125 may be configured as or otherwise support a means for transmitting a set of multiple control messages, where a first control message of the set of multiple control messages indicates the quantity of transmit antennas that are activated at the network entity at a first time, and where one or more other control messages of the set of multiple control messages indicate one or more other quantities of transmit antennas that are activated at the network entity at one or more other times different than the first time.

In some examples, to support transmitting the set of multiple control messages, the control signaling component 1125 may be configured as or otherwise support a means for transmitting the set of multiple control messages periodically, where each of the set of multiple control messages indicates a respective quantity of transmit antennas that are activated at the network entity at a respective time period associated with a periodicity of the set of multiple control messages.

In some examples, to support transmitting the set of multiple control messages, the transmission antenna component 1145 may be configured as or otherwise support a means for determining a change in the quantity of transmit antennas that are activated at the network entity. In some examples, to support transmitting the set of multiple control messages, the control signaling component 1125 may be configured as or otherwise support a means for transmitting a control message of the set of multiple control messages to indicate the change in the quantity of transmit antennas, where the set of multiple control messages are transmitted aperiodically or periodically, and where one or more of the set of multiple control messages indicates a respective change in the quantity of transmit antennas at the network entity.

In some examples, to support transmitting the control signaling, the control signaling component 1125 may be configured as or otherwise support a means for transmitting DCI that indicates the quantity of transmit antennas.

In some examples, to support transmitting the control signaling, the control signaling component 1125 may be configured as or otherwise support a means for transmitting RRC signaling that indicates the quantity of transmit antennas.

In some examples, the CSI report component 1130 may be configured as or otherwise support a means for receiving, after receiving the CSI report, a second CSI report that indicates a second set of one or more CSI parameters, where a difference between the set of one or more CSI parameters indicated via the CSI report and the second set of one or more CSI parameters indicated via the second CSI report is based on the quantity of antennas at the network entity and a change in one or more channel parameters associated with communications between the network entity and the UE. In some examples, the downlink transmission component 1140 may be configured as or otherwise support a means for transmitting a second downlink transmission based on the second set of one or more CSI parameters indicated via the second CSI report.

In some examples, a value of each CSI parameter of the set of one or more CSI parameters is correlated to the quantity of transmit antennas at the network entity. In some examples, the set of one or more CSI parameters includes a PMI, a rank, an MCS, or any combination thereof for transmitting the downlink transmission.

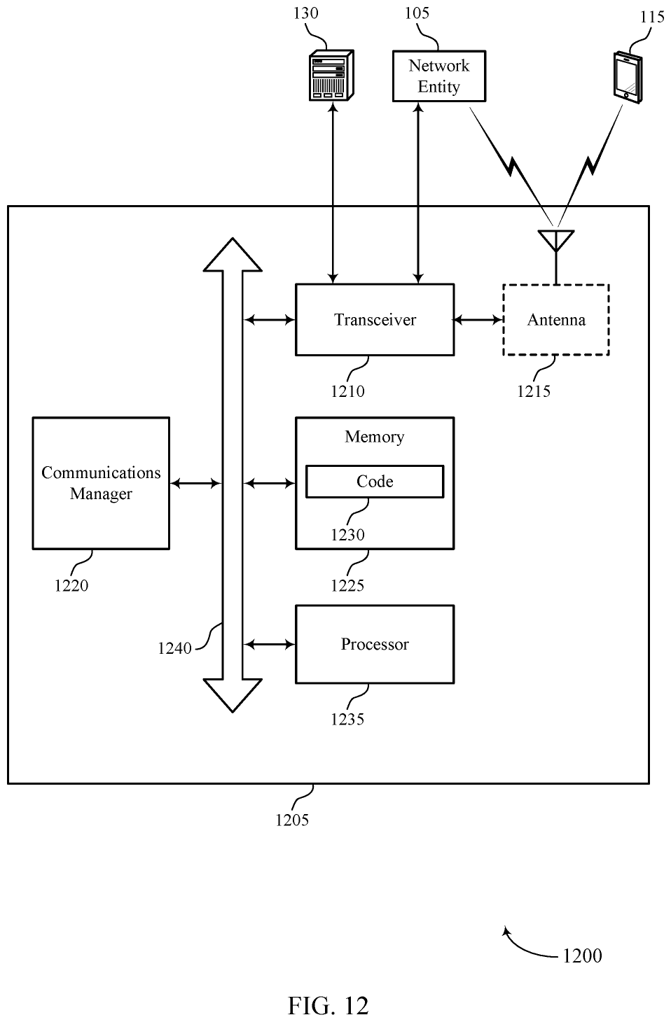

FIG. 12 shows a diagram of a system 1200 including a device 1205 that supports reporting quantity of transmit antennas for wireless communications in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting reporting quantity of transmit antennas for wireless communications). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205 and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105 and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

Additionally, or alternatively, the communications manager 1220 may support wireless communication at a network entity in accordance with examples as disclosed herein. For example, the communications manager 1220 may be configured as or otherwise support a means for transmitting control signaling that indicates a quantity of transmit antennas at the network entity, the quantity of transmit antennas including antennas that are activated for a downlink transmission to a UE. The communications manager 1220 may be configured as or otherwise support a means for receiving a CSI report including a set of one or more CSI parameters, the set of one or more CSI parameters based on the indicated quantity of transmit antennas at the network entity. The communications manager 1220 may be configured as or otherwise support a means for communicating with the UE based on the set of one or more CSI parameters indicated via the CSI report.

By including or configuring the communications manager 1220 in accordance with examples as described herein, the device 1205 may support techniques for improved communication reliability, reduced latency, improved user experience related to reduced processing, reduced power consumption improved coordination between devices, and longer battery life. For example, by transmitting an indication of a quantity of transmit antennas that are activated at the device 1205 (e.g., a network entity), the device 1205 may improve coordination between the device 1205 and one or more other devices (e.g., UEs) in communication with the device. Additionally, or alternatively, the indicated quantity of transmit antennas may be used by the other devices to improve CSI reporting accuracy and reduce complexity, which may reduce power consumption, reduce overhead, improve throughput, and improve reliability of the communications at the device 1205.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of reporting quantity of transmit antennas for wireless communications as described herein, or the processor 1235 and the memory 1225 may be otherwise configured to perform or support such operations.

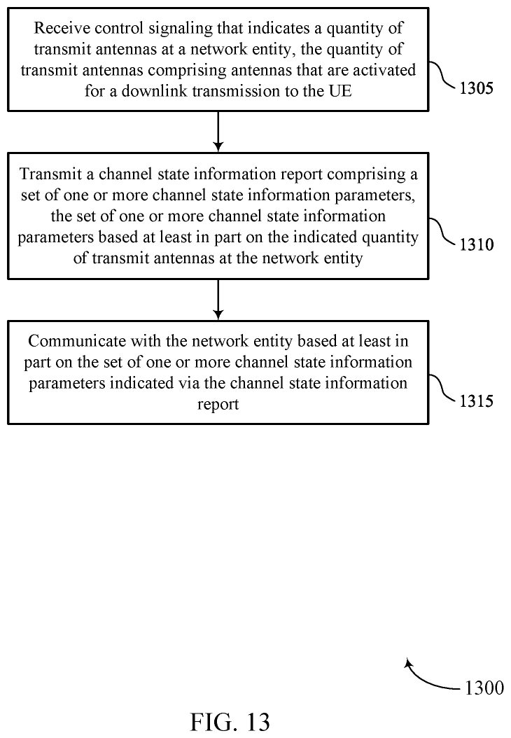

FIG. 13 shows a flowchart illustrating a method 1300 that supports reporting quantity of transmit antennas for wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that indicates a quantity of transmit antennas at a network entity, the quantity of transmit antennas including antennas that are activated for a downlink transmission to the UE. The operations of 1305 may be performed in accordance with examples as disclosed herein. In some examples, aspects of the operations of 1305 may be performed by a control signaling component 725 as described with reference to FIG. 7.

At 1310, the method may include transmitting a CSI report including a set of one or more CSI parameters, the set of one or more CSI parameters based on the indicated quantity of transmit antennas at the network entity. The operations of 1310 may be performed in accordance with examples as disclosed herein. In some examples, aspects of the operations of 1310 may be performed by a CSI report component 730 as described with reference to FIG. 7.

At 1315, the method may include communicating with the network entity based on the set of one or more CSI parameters indicated via the CSI report. The operations of 1315 may be performed in accordance with examples as disclosed herein. In some examples, aspects of the operations of 1315 may be performed by a communication component 735 as described with reference to FIG. 7.

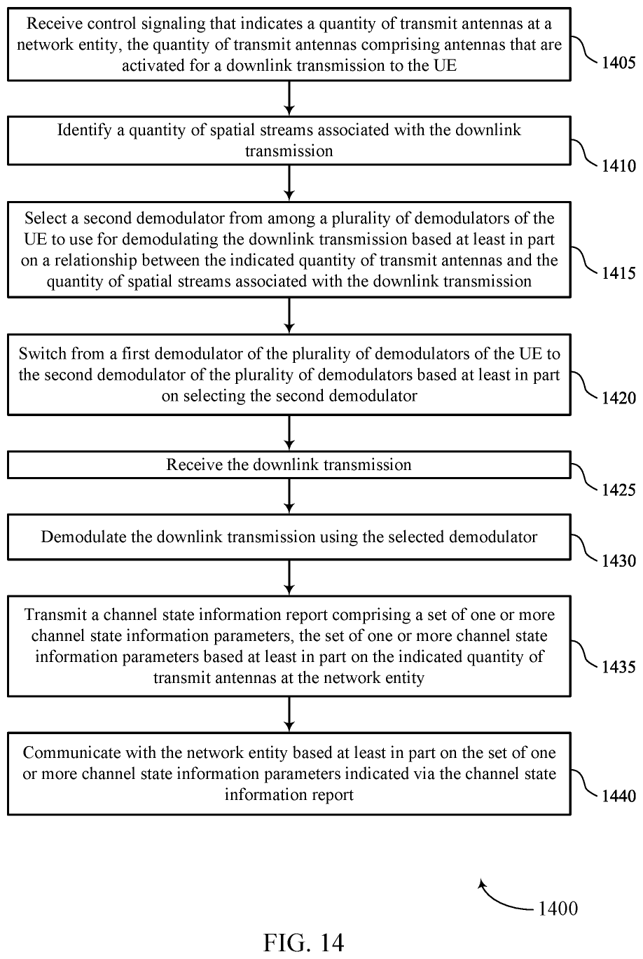

FIG. 14 shows a flowchart illustrating a method 1400 that supports reporting quantity of transmit antennas for wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates a quantity of transmit antennas at a network entity, the quantity of transmit antennas including antennas that are activated for a downlink transmission to the UE. The operations of 1405 may be performed in accordance with examples as disclosed herein. In some examples, aspects of the operations of 1405 may be performed by a control signaling component 725 as described with reference to FIG. 7.

At 1410, the method may include identifying a quantity of spatial streams associated with the downlink transmission. The operations of 1410 may be performed in accordance with examples as disclosed herein. In some examples, aspects of the operations of 1410 may be performed by a spatial stream identifier 755 as described with reference to FIG. 7.

At 1415, the method may include selecting a second demodulator from among the set of multiple demodulators of the UE to use for demodulating the downlink transmission based on a relationship between the indicated quantity of transmit antennas and the quantity of spatial streams associated with the downlink transmission The operations of 1415 may be performed in accordance with examples as disclosed herein. In some examples, aspects of the operations of 1415 may be performed by a demodulator switching component 740 as described with reference to FIG. 7.

At 1420, the method may include switching from a first demodulator of the set of multiple demodulators of the UE to the second demodulator of the set of multiple demodulators based on selecting the second demodulator. The operations of 1420 may be performed in accordance with examples as disclosed herein. In some examples, aspects of the operations of 1420 may be performed by a demodulator switching component 740 as described with reference to FIG. 7.

At 1425, the method may include receiving the downlink transmission. The operations of 1425 may be performed in accordance with examples as disclosed herein. In some examples, aspects of the operations of 1425 may be performed by a downlink transmission component 760 as described with reference to FIG. 7.

At 1430, the method may include demodulating the downlink transmission using the selected demodulator. The operations of 1430 may be performed in accordance with examples as disclosed herein. In some examples, aspects of the operations of 1430 may be performed by a demodulation component 765 as described with reference to FIG. 7.

At 1435, the method may include transmitting a CSI report including a set of one or more CSI parameters, the set of one or more CSI parameters based on the indicated quantity of transmit antennas at the network entity. The operations of 1435 may be performed in accordance with examples as disclosed herein. In some examples, aspects of the operations of 1435 may be performed by a CSI report component 730 as described with reference to FIG. 7.

At 1440, the method may include communicating with the network entity based on the set of one or more CSI parameters indicated via the CSI report. The operations of 1440 may be performed in accordance with examples as disclosed herein. In some examples, aspects of the operations of 1440 may be performed by a communication component 735 as described with reference to FIG. 7.

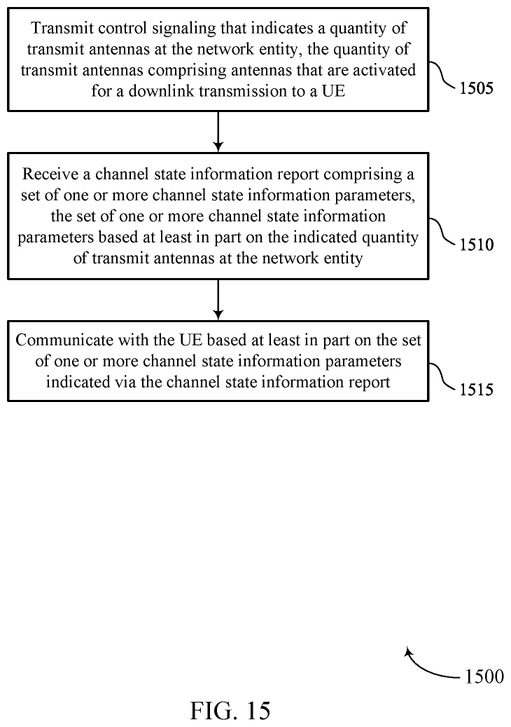

FIG. 15 shows a flowchart illustrating a method 1500 that supports reporting quantity of transmit antennas for wireless communications in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling that indicates a quantity of transmit antennas at the network entity, the quantity of transmit antennas including antennas that are activated for a downlink transmission to a UE. The operations of 1505 may be performed in accordance with examples as disclosed herein. In some examples, aspects of the operations of 1505 may be performed by a control signaling component 1125 as described with reference to FIG. 11.

At 1510, the method may include receiving a CSI report including a set of one or more CSI parameters, the set of one or more CSI parameters based on the indicated quantity of transmit antennas at the network entity. The operations of 1510 may be performed in accordance with examples as disclosed herein. In some examples, aspects of the operations of 1510 may be performed by a CSI report component 1130 as described with reference to FIG. 11.

At 1515, the method may include communicating with the UE based on the set of one or more CSI parameters indicated via the CSI report. The operations of 1515 may be performed in accordance with examples as disclosed herein. In some examples, aspects of the operations of 1515 may be performed by a communication component 1135 as described with reference to FIG. 11.

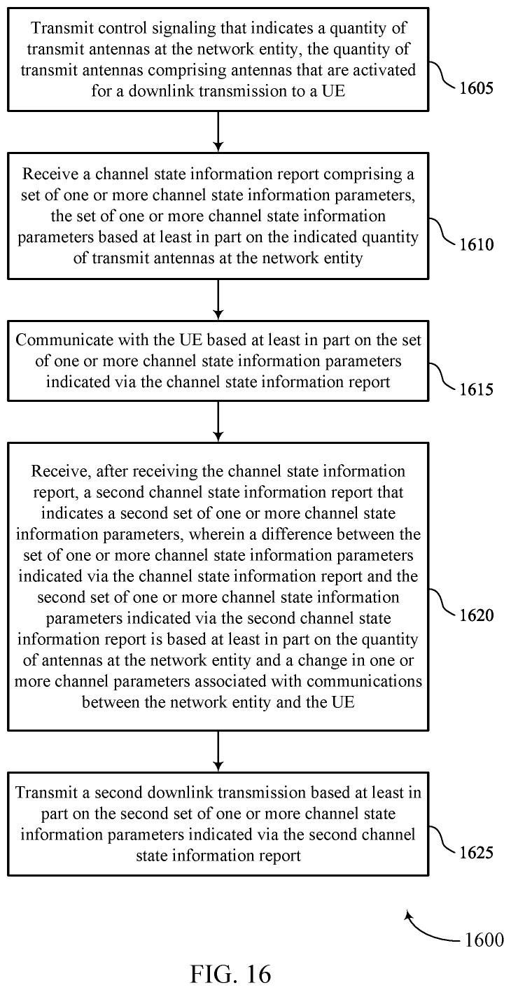

FIG. 16 shows a flowchart illustrating a method 1600 that supports reporting quantity of transmit antennas for wireless communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling that indicates a quantity of transmit antennas at the network entity, the quantity of transmit antennas including antennas that are activated for a downlink transmission to a UE. The operations of 1605 may be performed in accordance with examples as disclosed herein. In some examples, aspects of the operations of 1605 may be performed by a control signaling component 1125 as described with reference to FIG. 11.

At 1610, the method may include receiving a CSI report including a set of one or more CSI parameters, the set of one or more CSI parameters based on the indicated quantity of transmit antennas at the network entity. The operations of 1610 may be performed in accordance with examples as disclosed herein. In some examples, aspects of the operations of 1610 may be performed by a CSI report component 1130 as described with reference to FIG. 11.

At 1615, the method may include communicating with the UE based on the set of one or more CSI parameters indicated via the CSI report. The operations of 1615 may be performed in accordance with examples as disclosed herein. In some examples, aspects of the operations of 1615 may be performed by a communication component 1135 as described with reference to FIG. 11.

At 1620, the method may include receiving, after receiving the CSI report, a second CSI report that indicates a second set of one or more CSI parameters, where a difference between the set of one or more CSI parameters indicated via the CSI report and the second set of one or more CSI parameters indicated via the second CSI report is based on the quantity of antennas at the network entity and a change in one or more channel parameters associated with communications between the network entity and the UE. The operations of 1620 may be performed in accordance with examples as disclosed herein. In some examples, aspects of the operations of 1620 may be performed by a CSI report component 1130 as described with reference to FIG. 11.

At 1625, the method may include transmitting a second downlink transmission based on the second set of one or more CSI parameters indicated via the second CSI report. The operations of 1625 may be performed in accordance with examples as disclosed herein. In some examples, aspects of the operations of 1625 may be performed by a downlink transmission component 1140 as described with reference to FIG. 11.

The following provides an overview of aspects of the present disclosure:
Aspect 1: A method for wireless communication at a UE, comprising: receiving control signaling that indicates a quantity of transmit antennas at a network entity, the quantity of transmit antennas comprising antennas that are activated for a downlink transmission to the UE; transmitting a CSI report comprising a set of one or more CSI parameters, the set of one or more CSI parameters based at least in part on the indicated quantity of transmit antennas at the network entity; and communicating with the network entity based at least in part on the set of one or more CSI parameters indicated via the CSI report.
Aspect 2: The method of aspect 1, wherein receiving the control signaling comprises: receiving a plurality of control messages, wherein a first control message of the plurality of control messages indicates the quantity of transmit antennas that are activated at the network entity at a first time, and wherein one or more other control messages of the plurality of control messages indicate one or more other quantities of transmit antennas that are activated at the network entity at one or more other times different than the first time.
Aspect 3: The method of aspect 2, wherein receiving the plurality of control messages comprises: receiving the plurality of control messages periodically, wherein each of the plurality of control messages indicates a respective quantity of transmit antennas that are activated at the network entity for a respective time period associated with a periodicity of the plurality of control messages.
Aspect 4: The method of aspect 2, wherein receiving the plurality of control messages comprises: receiving the plurality of control messages aperiodically or periodically, wherein one or more the plurality of control messages indicates a respective change in the quantity of transmit antennas that are activated at the network entity.
Aspect 5: The method of any of aspects 1 through 4, wherein receiving the control signaling comprises: receiving DCI that indicates the quantity of transmit antennas.
Aspect 6: The method of any of aspects 1 through 4, wherein receiving the control signaling comprises: receiving RRC signaling that indicates the quantity of transmit antennas.
Aspect 7: The method of any of aspects 1 through 6, further comprising: switching from a first demodulator of a plurality of demodulators of the UE to a second demodulator of the plurality of demodulators based at least in part on the indicated quantity of transmit antennas.
Aspect 8: The method of aspect 7, further comprising: identifying a quantity of spatial streams associated with the downlink transmission; selecting the second demodulator from among the plurality of demodulators of the UE to use for demodulating the downlink transmission based at least in part on a relationship between the indicated quantity of transmit antennas and the quantity of spatial streams associated with the downlink transmission, wherein switching from the first demodulator to the second demodulator is based at least in part on selecting the second demodulator; receiving the downlink transmission; and demodulating the downlink transmission using the selected demodulator.
Aspect 9: The method of aspect 7, wherein each demodulator of the plurality of demodulators of the UE is associated with a respective demodulation complexity, and wherein the method further comprises: determining that the indicated quantity of transmit antennas is greater than a quantity of spatial streams associated with the downlink transmission by at least a threshold quantity or threshold ratio; and selecting the second demodulator associated with a second complexity that is less than a first complexity associated with the first demodulator and one or more other complexities associated with one or more other demodulators of the plurality of demodulators based at least in part on the determining, wherein switching from the first demodulator to the second demodulator is based at least in part on selecting the second demodulator.
Aspect 10: The method of any of aspects 1 through 9, further comprising: detecting a change in one or more channel parameters associated with communications between the UE and the network entity; and transmitting a second CSI report to indicate a second set of one or more CSI parameters in response to detecting the change, wherein a difference between the set of one or more CSI parameters and the second set of one or more CSI parameters is based at least in part on the indicated quantity of antennas at the network entity and the change in the one or more channel parameters.
Aspect 11: The method of any of aspects 1 through 10, further comprising: determining the set of one or more CSI parameters based at least in part on conditions at the UE and the indicated quantity of transmit antennas at the network entity, wherein a value of each CSI parameter of the set of one or more CSI parameters is correlated to the quantity of transmit antennas at the network entity.
Aspect 12: The method of any of aspects 1 through 11, wherein the set of one or more CSI parameters comprises a PMI, a rank, a MCS, or any combination thereof for receiving the downlink transmission.
Aspect 13: A method for wireless communication at a network entity, comprising: transmitting control signaling that indicates a quantity of transmit antennas at the network entity, the quantity of transmit antennas comprising antennas that are activated for a downlink transmission to a UE; receiving a CSI report comprising a set of one or more CSI parameters, the set of one or more CSI parameters based at least in part on the indicated quantity of transmit antennas at the network entity; and communicating with the UE based at least in part on the set of one or more CSI parameters indicated via the CSI report.
Aspect 14: The method of aspect 13, wherein transmitting the control signaling comprises: transmitting a plurality of control messages, wherein a first control message of the plurality of control messages indicates the quantity of transmit antennas that are activated at the network entity at a first time, and wherein one or more other control messages of the plurality of control messages indicate one or more other quantities of transmit antennas that are activated at the network entity at one or more other times different than the first time.
Aspect 15: The method of aspect 14, wherein transmitting the plurality of control messages comprises: transmitting the plurality of control messages periodically, wherein each of the plurality of control messages indicates a respective quantity of transmit antennas that are activated at the network entity at a respective time period associated with a periodicity of the plurality of control messages.
Aspect 16: The method of aspect 14, wherein transmitting the plurality of control messages comprises: determining a change in the quantity of transmit antennas that are activated at the network entity; and transmitting a control message of the plurality of control messages to indicate the change in the quantity of transmit antennas, wherein the plurality of control messages are transmitted aperiodically or periodically, and wherein one or more of the plurality of control messages indicates a respective change in the quantity of transmit antennas at the network entity.
Aspect 17: The method of any of aspects 13 through 16, wherein transmitting the control signaling comprises: transmitting DCI that indicates the quantity of transmit antennas.
Aspect 18: The method of any of aspects 13 through 16, wherein transmitting the control signaling comprises: transmitting RRC signaling that indicates the quantity of transmit antennas.
Aspect 19: The method of any of aspects 13 through 18, further comprising: receiving, after receiving the CSI report, a second CSI report that indicates a second set of one or more CSI parameters, wherein a difference between the set of one or more CSI parameters indicated via the CSI report and the second set of one or more CSI parameters indicated via the second CSI report is based at least in part on the quantity of antennas at the network entity and a change in one or more channel parameters associated with communications between the network entity and the UE; and transmitting a second downlink transmission based at least in part on the second set of one or more CSI parameters indicated via the second CSI report.
Aspect 20: The method of any of aspects 13 through 19, wherein a value of each CSI parameter of the set of one or more CSI parameters is correlated to the quantity of transmit antennas at the network entity.
Aspect 21: The method of any of aspects 13 through 20, wherein the set of one or more CSI parameters comprises a PMI, a rank, a MCS, or any combination thereof for transmitting the downlink transmission.
Aspect 22: An apparatus for wireless communication at a UE, comprising a processor; memory coupled with the processor; and instructions stored in the memory and executable by the processor to cause the apparatus to perform a method of any of aspects 1 through 12.
Aspect 23: An apparatus for wireless communication at a UE, comprising at least one means for performing a method of any of aspects 1 through 12.
Aspect 24: A non-transitory computer-readable medium storing code for wireless communication at a UE, the code comprising instructions executable by a processor to perform a method of any of aspects 1 through 12.
Aspect 25: An apparatus for wireless communication at a network entity, comprising a processor; memory coupled with the processor; and instructions stored in the memory and executable by the processor to cause the apparatus to perform a method of any of aspects 13 through 21.
Aspect 26: An apparatus for wireless communication at a network entity, comprising at least one means for performing a method of any of aspects 13 through 21.
Aspect 27: A non-transitory computer-readable medium storing code for wireless communication at a network entity, the code comprising instructions executable by a processor to perform a method of any of aspects 13 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive control signaling that indicates a quantity of transmit antennas at a network entity, the quantity of transmit antennas comprising antennas that are activated for a downlink transmission to the UE;
transmit a channel state information report comprising a set of one or more channel state information parameters, the set of one or more channel state information parameters based at least in part on the indicated quantity of transmit antennas at the network entity; and
communicate with the network entity based at least in part on the set of one or more channel state information parameters indicated via the channel state information report.

2. The apparatus of claim 1, wherein, to receive the control signaling, the instructions are executable by the processor to cause the apparatus to:
receive a plurality of control messages, wherein a first control message of the plurality of control messages indicates the quantity of transmit antennas that are activated at the network entity at a first time, and wherein one or more other control messages of the plurality of control messages indicate one or more other quantities of transmit antennas that are activated at the network entity at one or more other times different than the first time.

3. The apparatus of claim 2, wherein, to receive the plurality of control messages, the instructions are executable by the processor to cause the apparatus to:
receive the plurality of control messages periodically, wherein each of the plurality of control messages indicates a respective quantity of transmit antennas that are activated at the network entity for a respective time period associated with a periodicity of the plurality of control messages.

4. The apparatus of claim 2, wherein, to receive the plurality of control messages, the instructions are executable by the processor to cause the apparatus to:
receive the plurality of control messages aperiodically or periodically, wherein one or more the plurality of control messages indicates a respective change in the quantity of transmit antennas that are activated at the network entity.

5. The apparatus of claim 1, wherein, to receive the control signaling, the instructions are executable by the processor to cause the apparatus to:
receive downlink control information that indicates the quantity of transmit antennas.

6. The apparatus of claim 1, wherein, to receive the control signaling, the instructions are executable by the processor to cause the apparatus to:
receive radio resource control signaling that indicates the quantity of transmit antennas.

7. The apparatus of claim 1, wherein the instructions are further executable by the processor to cause the apparatus to:
switch from a first demodulator of a plurality of demodulators of the UE to a second demodulator of the plurality of demodulators based at least in part on the indicated quantity of transmit antennas.

8. The apparatus of claim 7, wherein the instructions are further executable by the processor to cause the apparatus to:
identify a quantity of spatial streams associated with the downlink transmission;
select the second demodulator from among the plurality of demodulators of the UE to use for demodulating the downlink transmission based at least in part on a relationship between the indicated quantity of transmit antennas and the quantity of spatial streams associated with the downlink transmission, wherein switching from the first demodulator to the second demodulator is based at least in part on selecting the second demodulator;
receive the downlink transmission; and
demodulate the downlink transmission using the selected demodulator.

9. The apparatus of claim 7, wherein each demodulator of the plurality of demodulators of the UE is associated with a respective demodulation complexity, and wherein the instructions are further executable by the processor to cause the apparatus to:
determine that the indicated quantity of transmit antennas is greater than a quantity of spatial streams associated with the downlink transmission by at least a threshold quantity or threshold ratio; and
select the second demodulator associated with a second complexity that is less than a first complexity associated with the first demodulator and one or more other complexities associated with one or more other demodulators of the plurality of demodulators based at least in part on the determining, wherein switching from the first demodulator to the second demodulator is based at least in part on selecting the second demodulator.

10. The apparatus of claim 1, wherein the instructions are further executable by the processor to cause the apparatus to:
detect a change in one or more channel parameters associated with communications between the UE and the network entity; and
transmit a second channel state information report to indicate a second set of one or more channel state information parameters in response to detecting the change, wherein a difference between the set of one or more channel state information parameters and the second set of one or more channel state information parameters is based at least in part on the indicated quantity of antennas at the network entity and the change in the one or more channel parameters.

11. The apparatus of claim 1, wherein the instructions are further executable by the processor to cause the apparatus to:
determine the set of one or more channel state information parameters based at least in part on conditions at the UE and the indicated quantity of transmit antennas at the network entity, wherein a value of each channel state information parameter of the set of one or more channel state information parameters is correlated to the quantity of transmit antennas at the network entity.

12. The apparatus of claim 1, wherein the set of one or more channel state information parameters comprises a precoding matrix indicator, a rank, a modulation and coding scheme, or any combination thereof for receiving the downlink transmission.

13. An apparatus for wireless communication at a network entity, comprising:
a processor;
memory coupled with the processor; and
instructions stored in the memory and executable by the processor to cause the apparatus to:
transmit control signaling that indicates a quantity of transmit antennas at the network entity, the quantity of transmit antennas comprising antennas that are activated for a downlink transmission to a user equipment (UE);
receive a channel state information report comprising a set of one or more channel state information parameters, the set of one or more channel state information parameters based at least in part on the indicated quantity of transmit antennas at the network entity; and
communicate with the UE based at least in part on the set of one or more channel state information parameters indicated via the channel state information report.

14. The apparatus of claim 13, wherein, to transmit the control signaling, the instructions are executable by the processor to cause the apparatus to:
transmit a plurality of control messages, wherein a first control message of the plurality of control messages indicates the quantity of transmit antennas that are activated at the network entity at a first time, and wherein one or more other control messages of the plurality of control messages indicate one or more other quantities of transmit antennas that are activated at the network entity at one or more other times different than the first time.

15. The apparatus of claim 14, wherein, to transmit the plurality of control messages, the instructions are executable by the processor to cause the apparatus to:
transmit the plurality of control messages periodically, wherein each of the plurality of control messages indicates a respective quantity of transmit antennas that are activated at the network entity at a respective time period associated with a periodicity of the plurality of control messages.

16. The apparatus of claim 14, wherein, to transmit the plurality of control messages, the instructions are executable by the processor to cause the apparatus to:
determine a change in the quantity of transmit antennas that are activated at the network entity; and
transmit a control message of the plurality of control messages to indicate the change in the quantity of transmit antennas, wherein the plurality of control messages are transmitted aperiodically or periodically, and wherein one or more of the plurality of control messages indicates a respective change in the quantity of transmit antennas at the network entity.

17. The apparatus of claim 13, wherein, to transmit the control signaling, the instructions are executable by the processor to cause the apparatus to:
transmit downlink control information that indicates the quantity of transmit antennas.

18. The apparatus of claim 13, wherein to transmit the control signaling, the instructions are executable by the processor to cause the apparatus to:
transmit radio resource control signaling that indicates the quantity of transmit antennas.

19. The apparatus of claim 13, wherein the instructions are further executable by the processor to cause the apparatus to:
receive, after receiving the channel state information report, a second channel state information report that indicates a second set of one or more channel state information parameters, wherein a difference between the set of one or more channel state information parameters indicated via the channel state information report and the second set of one or more channel state information parameters indicated via the second channel state information report is based at least in part on the quantity of antennas at the network entity and a change in one or more channel parameters associated with communications between the network entity and the UE; and
transmit a second downlink transmission based at least in part on the second set of one or more channel state information parameters indicated via the second channel state information report.

20. The apparatus of claim 13, wherein a value of each channel state information parameter of the set of one or more channel state information parameters is correlated to the quantity of transmit antennas at the network entity.

21. The apparatus of claim 13, wherein the set of one or more channel state information parameters comprises a precoding matrix indicator, a rank, a modulation and coding scheme, or any combination thereof for transmitting the downlink transmission.

22. A method for wireless communication at a user equipment (UE), comprising:
receiving control signaling that indicates a quantity of transmit antennas at a network entity, the quantity of transmit antennas comprising antennas that are activated for a downlink transmission to the UE;
transmitting a channel state information report comprising a set of one or more channel state information parameters, the set of one or more channel state information parameters based at least in part on the indicated quantity of transmit antennas at the network entity; and
communicating with the network entity based at least in part on the set of one or more channel state information parameters indicated via the channel state information report.

23. The method of claim 22, wherein receiving the control signaling comprises:
receiving a plurality of control messages, wherein a first control message of the plurality of control messages indicates the quantity of transmit antennas that are activated at the network entity at a first time, and wherein one or more other control messages of the plurality of control messages indicate one or more other quantities of transmit antennas that are activated at the network entity at one or more other times different than the first time.

24. The method of claim 23, wherein receiving the plurality of control messages comprises:
receiving the plurality of control messages periodically, wherein each of the plurality of control messages indicates a respective quantity of transmit antennas that are activated at the network entity for a respective time period associated with a periodicity of the plurality of control messages.

25. The method of claim 23, wherein receiving the plurality of control messages comprises:
receiving the plurality of control messages aperiodically or periodically, wherein one or more the plurality of control messages indicates a respective change in the quantity of transmit antennas that are activated at the network entity.

26. The method of claim 22, further comprising:
switching from a first demodulator of a plurality of demodulators of the UE to a second demodulator of the plurality of demodulators based at least in part on the indicated quantity of transmit antennas.

27. A method for wireless communication at a network entity, comprising:
transmitting control signaling that indicates a quantity of transmit antennas at the network entity, the quantity of transmit antennas comprising antennas that are activated for a downlink transmission to a user equipment (UE);
receiving a channel state information report comprising a set of one or more channel state information parameters, the set of one or more channel state information parameters based at least in part on the indicated quantity of transmit antennas at the network entity; and
communicating with the UE based at least in part on the set of one or more channel state information parameters indicated via the channel state information report.

28. The method of claim 27, wherein transmitting the control signaling comprises:
transmitting a plurality of control messages, wherein a first control message of the plurality of control messages indicates the quantity of transmit antennas that are activated at the network entity at a first time, and wherein one or more other control messages of the plurality of control messages indicate one or more other quantities of transmit antennas that are activated at the network entity at one or more other times different than the first time.

29. The method of claim 28, wherein transmitting the plurality of control messages comprises:
transmitting the plurality of control messages periodically, wherein each of the plurality of control messages indicates a respective quantity of transmit antennas that are activated at the network entity at a respective time period associated with a periodicity of the plurality of control messages.

30. The method of claim 28, wherein transmitting the plurality of control messages comprises:
determining a change in the quantity of transmit antennas that are activated at the network entity; and
transmitting a control message of the plurality of control messages to indicate the change in the quantity of transmit antennas, wherein the plurality of control messages are transmitted aperiodically or periodically, and wherein one or more of the plurality of control messages indicates a respective change in the quantity of transmit antennas at the network entity.
